(19) United States
(12) Patent Application Publication
(10) Pub. No.: US 2022/0417842 A1
(43) Pub. Date: Dec. 29, 2022

(54) INFORMATION PROCESSING METHOD AND COMMUNICATION APPARATUS

(71) Applicant: HUAWEI TECHNOLOGIES CO., LTD., Shenzhen (CN)

(72) Inventors: Shuigen YANG, Shenzhen (CN); Feng HAN, Shanghai (CN); Wei TAN, Shanghai (CN)

(21) Appl. No.: 17/902,012

(22) Filed: Sep. 2, 2022

Related U.S. Application Data
(63) Continuation of application No. PCT/CN2020/078310, filed on Mar. 6, 2020.

(51) Int. Cl. H04W 48/18; H04W 24/10

(52) U.S. Cl. CPC H04W 48/18; H04W 24/10

(57) ABSTRACT

An information processing method includes a first access network device sending application layer measurement configuration information to a terminal, and the first access network device receiving an application layer measurement report from the terminal. The application layer measurement configuration information includes identification information. The identification information indicates a network slice. The application layer measurement report includes an application layer measurement result of the network slice.

### CROSS-REFERENCE TO RELATED APPLICATIONS

This application is a continuation of International Application No. PCT/CN2020/078310, filed on Mar. 6, 2020, the disclosure of which is hereby incorporated in entirety by reference.

### BACKGROUND

Quality of experience (quality of experience, QoE) refers to subjective experience of a user on quality and performance of a network, a service, or the like. A QoE condition is related to a terminal, and is further related to a service. Different terminals correspond to different QoE conditions, and different services correspond to different QoE conditions. A carrier provides various services for a terminal user, and tries to meet a QoE condition of the user.

To meet the QoE condition of the user as much as possible, the carrier collects QoE measurement data, for example, data such as a frame rate and jitter duration of a service run by the terminal, and reallocate a resource to the terminal or the service based on the measurement data, to achieve an objective of network optimization. Currently, a procedure for the carrier to collect QoE measurement data is as follows. A network side sends application layer measurement configuration information to a terminal. The application layer measurement configuration information includes a service type. The terminal performs QoE measurement collection on a service corresponding to the application layer measurement configuration information, and sends a measurement result to the network side. The network side indicates the terminal to perform application layer measurement on one service at a time.

Currently, the terminal supports a streaming service and a multimedia telephony service for IP multimedia subsystem (multimedia telephony service for IP multimedia subsystem, MTSI). A network slice (network slice) is introduced into 5G. One physical network is abstracted into a plurality of network slices. Each network slice flexibly provides one or more services based on a condition of a demander. A network system into which the network slice is introduced supports a plurality of serving types, for example, enhanced mobile broadband (enhanced mobile broadband, eMBB), ultra-reliable low-latency communication (ultra-reliable low-latency communication, URLLC), Massive Internet of Things (massive Internet of things, MIoT), and vehicle to everything (vehicle to everything, V2X). In an application scenario in which the network slice is introduced, if a current procedure of collecting QoE measurement data is still used, the network side needs to send the application layer measurement configuration information for a plurality of times. Consequently, overheads are large.

### SUMMARY

In some embodiments, an information processing method and a communication apparatus, to enable a terminal to perform QoE measurement collection on a plurality of service types with less signaling interaction is discussed.

According to a first aspect, an information processing method is provided. The method is performed by a first communication apparatus. The first communication apparatus is a communication device or a communication apparatus that supports the communication device in implementing functions required for the method, for example, a chip system. An example in which the communication device is a first access network device is used below for descriptions. The method includes:

The first access network device sends application layer measurement configuration information to a terminal. The application layer measurement configuration information includes identification information. The identification information indicates a network slice.

The first access network device receives an application layer measurement report from the terminal. The application layer measurement report includes an application layer measurement result of the network slice.

In some embodiments, the application layer measurement configuration information sent by a network side to the terminal includes the identification information indicating the network slice, that is, network slice information that is used by the network side to indicate the terminal to perform application layer measurement. Because one network slice is associated with a plurality of service types of the terminal, for example, a network slice of a V2X serving type is associated with a streaming service and an MTSI service, in this method, the network side needs to send the application layer measurement configuration information once, so that the terminal performs application layer measurement on a plurality of services, that is, perform quality of experience measurement collection. This may reduce a quantity of times of information exchange between the network side and the terminal, and reduce overheads.

In a possible implementation, the identification information includes single network slice selection assistance information (single network slice selection assistance information) S-NSSAI.

In a possible implementation, the application layer measurement configuration information further includes a service type. The application layer measurement configuration information indicates to perform quality of experience measurement collection on the service type in the network slice.

In some embodiments, serving types includes a URLLC type, a MIoT type, an eMBB type, a V2X type, and the like that are supported by the network slice. Each serving type supports at least one service type. When one network slice supports a plurality of service types, or one service type is implemented by using a plurality of network slices, an application layer measurement report of a service type in a network slice is obtained by using the method, to optimize the network slice.

In a possible implementation, the method further includes: The first access network device receives a first message from a network device. The first message includes the application layer measurement configuration information. In some scenarios, the first access network device does not know whether the terminal is indicated to perform quality of experience measurement collection on the network slice or the service type in the network slice, but another network device knows. Therefore, the first access network device sends the application layer measurement configuration information to the terminal under triggering of the other network device, so that the first access network device optimizes the network slice based on a result of performing application layer measurement by the terminal on the network slice or the service type in the network slice.

In a possible implementation, the method further includes: The first access network device receives capability information from the terminal. The capability information indicates that the terminal supports application layer measurement collection, for example, quality of experience measurement collection, of the network slice. In this solution, the terminal actively sends the capability information to the first access network device. This avoids, as much as possible, a resource waste caused because the first access network device sends, to a terminal that does not support application layer measurement collection on the network slice, the application layer measurement configuration information that carries the identification information of the network slice.

In a possible implementation, before the first access network device receives capability information from the terminal, the method further includes:

The first access network device sends a second message to the terminal. The second message is used to request to obtain the capability information of the terminal. In this solution, the terminal sends the capability information to the first access network device based on a condition of the first access network device, to further reduce information exchange between the network side and the terminal side, and reduce signaling overheads.

In a possible implementation, the method further includes:

The first access network device sends capability information of the terminal to the network device. The capability information indicates that the terminal supports quality of experience measurement collection on the network slice. In this solution, the first access network device actively sends the capability information to the network device. This avoids, as much as possible, a resource waste caused because the network device obtains the application layer measurement result of the network slice from the terminal that does not support quality of experience measurement collection on the network slice.

In a possible implementation, before the first access network device sends capability information of the terminal to the network device, the method further includes:

The first access network device receives a third message from the network device. The third message is used to request to obtain the capability information of the terminal. In this solution, the first access network device sends the capability information to the network device based on a condition of the network device. This avoids a resource waste caused because the first access network device sends the capability information to the network device for a large quantity of times.

In some embodiments, solutions provided is applied to a separate first access network device. In a possible implementation, the first access network device includes a central unit (central unit, CU) and a distributed unit (distributed unit, DU). That the first access network device sends application layer measurement configuration information to a terminal includes:

The CU in the first access network device sends the application layer measurement configuration information to the terminal.

In a possible implementation, the first access network device includes the CU and the DU. That the first access network device receives an application layer measurement report from the terminal includes:

The CU in the first access network device receives the application layer measurement report from the terminal.

In a possible implementation, the method further includes:

The CU in the first access network device sends the application layer measurement report of the terminal to the DU in the first access network device.

In another possible implementation, the CU includes a CU control plane (CU-CP) and a CU user plane (CU-UP). That the first access network device sends application layer measurement configuration information to a terminal includes:

The CU-CP in the first access network device sends the application layer measurement configuration information to the terminal.

That the first access network device receives an application layer measurement report from the terminal includes:

The CU-CP in the first access network device receives the application layer measurement report from the terminal, and sends the application layer measurement report of the terminal to the DU in the first access network device.

According to a second aspect, an information processing method is provided. The method is performed by a second communication apparatus. The second communication apparatus is a communication device or a communication apparatus that supports the communication device in implementing functions required for the method, for example, a chip system. An example in which the communication device is a terminal is used below for descriptions. The method includes:

The terminal receives application layer measurement configuration information from a first access network device. The application layer measurement configuration information includes identification information. The identification information indicates a network slice.

The terminal sends an application layer measurement report to the first access network device. The application layer measurement report includes an application layer measurement result of the network slice.

In a possible implementation, the identification information includes S-NSSAI.

In a possible implementation, the application layer measurement configuration information further includes a service type. The application layer measurement configuration information indicates to perform quality of experience measurement collection on the service type in the network slice.

In a possible implementation, the method further includes:

The terminal sends capability information to the first access network device. The capability information indicates that the terminal supports application layer measurement collection, for example, quality of experience measurement collection, of the network slice.

In a possible implementation, before the terminal sends capability information to the first access network device, the method further includes:

The terminal receives a second message from the first access network device. The second message is used to request to obtain the capability information of the terminal.

For technical effects brought by the second aspect or the possible implementations of the second aspect, refer to the descriptions of the technical effects brought by the first aspect or the possible implementations of the first aspect.

According to a third aspect, an information processing method is provided. The method is performed by a third communication apparatus. The third communication apparatus is a communication device or a communication apparatus that supports the communication device in implementing functions required for the method, for example, a chip system. An example in which the communication device is a network device is used below for descriptions. The method includes:

The network device determines a first message. The first message includes application layer measurement configuration information.

The network device sends the first message to a first access network device.

In a possible implementation, the method further includes:

The network device receives capability information of a terminal from the first access network device. The capability information indicates that the terminal supports application layer measurement collection, for example, quality of experience measurement collection, of a network slice.

In a possible implementation, before the network device receives capability information of a terminal from the first access network device, the method further includes:

The network device sends a second message to the first access network device. The second message is used to request to obtain the capability information of the terminal.

For technical effects brought by the third aspect or the possible implementations of the third aspect, refer to the descriptions of the technical effects brought by the first aspect or the possible implementations of the first aspect.

According to a fourth aspect, an information processing method is provided. The method is performed by a first communication apparatus. The first communication apparatus is a communication device or a communication apparatus that supports the communication device in implementing functions required for the method, for example, a chip system. An example in which the communication device is a first access network device is used below for descriptions. The method includes:

The first access network device receives first application layer measurement configuration information from a network device. The first application layer measurement configuration information includes identification information and a service type. The identification information indicates a network slice.

The first access network device sends second application layer measurement configuration information to a terminal. The second application layer measurement configuration information indicates the terminal to perform quality of experience measurement collection on the service type.

The first access network device receives an application layer measurement report from the terminal. The application layer measurement report includes a result of performing application layer measurement by the terminal on the service type.

Different from the first aspect, in this aspect, the application layer measurement configuration information sent by the first access network device to the terminal includes the service type, but does not include the identification information. The application layer measurement configuration information indicates a service on which the terminal performs application layer measurement. The first access network device may learn, based on the first application layer measurement configuration information sent by the network device, that the identification information uniquely corresponds to a serving type. Therefore, the first access network device obtains an application layer measurement result related to the network slice without notifying the terminal of information about a network slice on which quality of experience measurement collection is performed.

According to a fifth aspect, an information processing method is provided. The method is performed by a second communication apparatus. The second communication apparatus is a communication device or a communication apparatus that supports the communication device in implementing functions required for the method, for example, a chip system. An example in which the communication device is a network device is used below for descriptions. The method includes:

The network device determines first application layer measurement configuration information. The first application layer measurement configuration information includes identification information and a service type. The identification information indicates a network slice.

The network device sends the first application layer measurement configuration information to a first access network device.

For technical effects brought by the fifth aspect or the possible implementations of the fifth aspect, refer to the descriptions of the technical effects brought by the fourth aspect or the possible implementations of the fourth aspect.

According to a sixth aspect, in some embodiments, a communication apparatus is discussed. For beneficial effects, refer to the descriptions in the first aspect. Details are not described herein again. The communication apparatus has a function of implementing behavior in the foregoing method embodiment of the first aspect. The function is implemented by hardware, or is implemented by hardware executing corresponding software. The hardware or the software includes one or more modules corresponding to the foregoing function. In a possible implementation, the communication apparatus includes a sending unit and a receiving unit. The sending unit is configured to send application layer measurement configuration information to a terminal. The application layer measurement configuration information includes identification information. The identification information indicates a network slice. The receiving unit is configured to receive an application layer measurement report from the terminal. The application layer measurement report includes an application layer measurement result of the network slice. These modules performs corresponding functions in the method examples in the first aspect. For details, refer to the detailed descriptions in the method examples. Details are not described herein again.

According to a seventh aspect, in some embodiments, a communication apparatus is discussed. For beneficial effects, refer to the descriptions in the second aspect. Details are not described herein again. The communication apparatus has a function of implementing behavior in the method embodiment of the second aspect. The function is implemented by hardware, or is implemented by hardware executing corresponding software. The hardware or the software includes one or more modules corresponding to the foregoing function. In a possible implementation, the communication apparatus includes a sending unit and a receiving unit. The receiving unit is configured to: receive application layer measurement configuration information from a first access network device. The application layer measurement configuration information includes identification information. The identification information indicates a network slice. The sending unit is configured to send an application layer measurement report to the first access network device. The application layer measurement report includes an application layer measurement result of the network slice. These modules performs corresponding functions in the method example in the second aspect. For details, refer to the detailed descriptions in the method example. Details are not described herein again.

According to an eighth aspect, in some embodiments, a communication apparatus is discussed. For beneficial effects, refer to the descriptions in the third aspect. Details are not described herein again. The communication apparatus has a function of implementing behavior in the method embodiment of the third aspect. The function is implemented by hardware, or is implemented by hardware executing corresponding software. The hardware or the software includes one or more modules corresponding to the foregoing function. In a possible implementation, the communication apparatus includes a processing unit and a transceiver unit. The processing unit is configured to determine a first message. The first message includes application layer measurement configuration information. The sending unit is configured to send the first message to a first access network device. These modules performs corresponding functions in the method example in the third aspect. For details, refer to the detailed descriptions in the method example. Details are not described herein again.

According to a ninth aspect, in some embodiments, a communication apparatus is discussed. For beneficial effects, refer to the descriptions in the fourth aspect. Details are not described herein again. The communication apparatus has a function of implementing behavior in the method embodiment of the fourth aspect. The function is implemented by hardware, or is implemented by hardware executing corresponding software. The hardware or the software includes one or more modules corresponding to the foregoing function. In a possible implementation, the communication apparatus includes a sending unit and a receiving unit. The receiving unit is configured to receive first application layer measurement configuration information from a network device. The first application layer measurement configuration information includes identification information and a service type. The identification information indicates a network slice. The sending unit is configured to send second application layer measurement configuration information to a terminal. The second application layer measurement configuration information indicates the terminal to perform quality of experience measurement collection on the service type. The receiving unit is further configured to receive an application layer measurement report from the terminal. The application layer measurement report includes a result of performing application layer measurement by the terminal on the service type. These modules performs corresponding functions in the method example in the fourth aspect. For details, refer to the detailed descriptions in the method example. Details are not described herein again.

According to a tenth aspect, in some embodiments, a communication apparatus is discussed. For beneficial effects, refer to the descriptions in the fifth aspect. Details are not described herein again. The communication apparatus has a function of implementing behavior in the method embodiment of the fifth aspect. The function is implemented by hardware, or is implemented by hardware executing corresponding software. The hardware or the software includes one or more modules corresponding to the foregoing function. In a possible implementation, the communication apparatus includes a determining unit and a transceiver unit. The determining unit is configured to determine first application layer measurement configuration information. The first application layer measurement configuration information includes identification information and a service type. The identification information indicates a network slice. The transceiver unit is configured to send the first application layer measurement configuration information to a first access network device. These modules performs corresponding functions in the method example in the fifth aspect. For details, refer to the detailed descriptions in the method example. Details are not described herein again.

According to an eleventh aspect, a communication apparatus is provided. The communication apparatus is the communication apparatus in the sixth aspect, the seventh aspect, the eighth aspect, the ninth aspect, or the tenth aspect in the foregoing method embodiments, or is a chip disposed in the communication apparatus in the sixth aspect, the seventh aspect, the eighth aspect, the ninth aspect, or the tenth aspect. The communication apparatus includes a processor, configured to implement the method performed by the first access network device, the network device, or the terminal in the first aspect, the second aspect, the third aspect, the fourth aspect, or the fifth aspect. The communication apparatus further includes a memory, configured to store program instructions and data. The memory is coupled to the processor. The processor may invoke and execute the program instructions stored in the memory, to implement any method performed by the first access network device, the network device, or the terminal in the first aspect, the second aspect, the third aspect, the fourth aspect, or the fifth aspect. The communication apparatus further includes a communication interface. The communication interface is a transceiver in the communication apparatus. The transceiver is implemented, for example, by using an antenna, a feeder, and a codec in the communication apparatus. Alternatively, if a fifth communication apparatus is a chip disposed in the network device, the communication interface is an input/output interface of the chip, for example, an input/output pin. The transceiver is used by the communication apparatus to communicate with another device. For example, when the communication apparatus is the terminal, the other device is the first access network device. Alternatively, when the communication apparatus is the first access network device, the other device is the terminal or the network device.

According to a twelfth aspect, in some embodiments, a chip system is discussed. The chip system includes a processor, and further includes a memory, configured to implement the method performed by the first access network device, the network device, or the terminal in the first aspect, the second aspect, the third aspect, the fourth aspect, or the fifth aspect. The chip system includes a chip, or includes a chip and another discrete component.

According to a thirteenth aspect, in some embodiments, a communication system is discussed. The system includes the communication apparatus according to the sixth aspect, the seventh aspect, and the eighth aspect, or the system includes the communication apparatus and the terminal according to the ninth aspect and the tenth aspect.

According to a fourteenth aspect, in some embodiments, a computer-readable storage medium that includes instructions is discussed. When the instructions are run on a computer, the computer is enabled to perform the method performed by the first access network device in the first aspect, the terminal in the second aspect, or the network device in the third aspect, or the computer is enabled to perform the method performed by the first access network device in the fourth aspect or the network device in the fifth aspect.

According to a fifteenth aspect, in some embodiments, a computer program product that includes computer program code is discussed. When the computer program code is run on a computer, the computer is enabled to perform the method performed by the first access network device in the first aspect, the terminal in the second aspect, or the network device in the third aspect, or the computer is enabled to perform the method performed by the first access network device in the fourth aspect or the network device in the fifth aspect.

For beneficial effects of the eleventh aspect to the fifteenth aspect and the implementations of the eleventh aspect to the fifteenth aspect, refer to the descriptions of beneficial effects of the to methods and the implementations of the methods in the first aspect to the fifth aspect.

### BRIEF DESCRIPTION OF DRAWINGS

FIG. 1 is a schematic diagram of a network architecture of network slices according to some embodiments;

FIG. 2 is a schematic diagram of a network architecture of a communication system in accordance with some embodiments;

FIG. 3 is a schematic flowchart of an example of an information processing method according to some embodiments;

FIG. 4 is a schematic flowchart of an example of an information processing method according to some embodiments;

FIG. 5 is a schematic flowchart of an example of an information processing method according to some embodiments;

FIG. 6 is a schematic flowchart of an example of an information processing method according to some embodiments;

FIG. 7 is a schematic flowchart of an example of an information processing method according to some embodiments;

FIG. 8 is a schematic flowchart of an example of an information processing method according to some embodiments;

FIG. 9 is a flowchart of an example of a communication apparatus according to some embodiments;

FIG. 10 is a schematic diagram of a structure of a communication apparatus according to some embodiments;

FIG. 11 is a schematic diagram of another structure of a communication apparatus according to some embodiments;

FIG. 12 is a schematic diagram of a structure of a communication apparatus according to some embodiments;

FIG. 13 is a schematic diagram of another structure of a communication apparatus according to some embodiments; and

FIG. 14 is a schematic diagram of another structure of a communication apparatus according to some embodiments.

### DESCRIPTION OF EMBODIMENTS

To make objectives, technical solutions, and advantages of embodiments clearer, the following further describes embodiments in detail with reference to the accompanying drawings.

Before this application is described, some terms in embodiments are first briefly explained and described, to help a person skilled in the art have a better understanding.

QoE refers to subjective experience of a user on quality and performance of a network, a service, or the like. An ultimate objective of a carrier is to provide various services for a terminal user. Therefore, a QoE condition of the user is helpful. To meet the QoE condition of the user as much as possible, the carrier collects QoE measurement data, for example, a frame rate and jitter duration of a service run by a terminal, to optimize a network, and optimize the network based on the measurement data.

Currently, the terminal supports a streaming service and an MTSI service. The streaming service is a service in which content such as a picture or a text is exchanged by using a Hypertext Transfer Protocol. That is, resources related to the streaming service is accessed by using the Hypertext Transfer Protocol, or the like. The MTSI service refers to a service that allows two or more users to perform multimedia session communication, and provides real-time voice, video, or another type of data in bidirectional dialog transmission. For example, the streaming service is, for example, a service related to a video application. The MTSI service is, for example, a service related to a voice application supported by the terminal. From this perspective, the streaming service and the MTSI service is considered as services related to applications of the terminal. A procedure for the carrier to collect QoE measurement data is as follows: A network side sends application layer measurement configuration information to a terminal. The application layer measurement configuration information includes a service type. The service type indicates the streaming service or the MTSI service. The terminal performs related measurement on a service corresponding to the application layer measurement configuration information, and sends a measurement result to the network side. The network side indicates the terminal to perform QoE measurement collection on one service at a time. If the network side requires the terminal to perform QoE measurement collection on both the services, the network side needs to send the application layer measurement configuration information to the terminal twice.

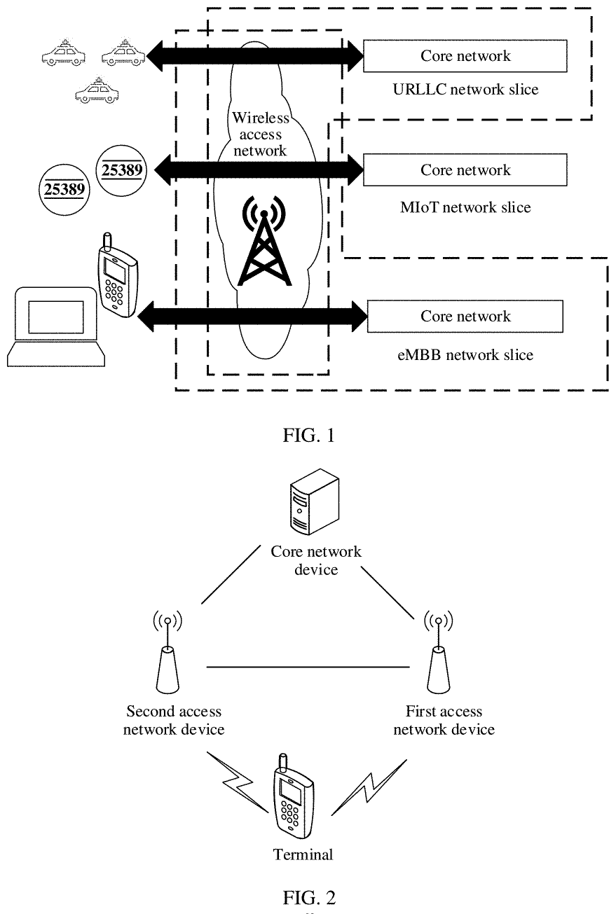

A network slice is introduced into a 5G communication system. The network slice is a logical network that provides network capabilities and network characteristics (A logical network that provides network capabilities and network characteristics). One physical network is abstracted into a plurality of network slices. FIG. 1 is a schematic diagram of a network architecture of network slices. Each network slice includes a radio access network and a core network slice. Different core network slices share the radio access network (which is shown by using dashed lines in FIG. 1). In some embodiments, the radio access network alternatively is network sliced. In this case, each network slice includes a radio access network slice and the core network slice. In some embodiments, the core network slice has a core network function, for example, an access and mobility management function (access and mobility management function, AMF) and/or a session management function (session management function, SMF), or another possible core network function. The AMF is mainly responsible for access control and mobility management. The SMF is connected to the AMF, and is mainly responsible for session management.

Different network slices are distinguished by using S-NSSAI. The S-NSSAI includes at least slice/serving type (slice/service type, SST) information. The SST information is used to describe expected behavior of the network slice, for example, a feature of the network slice and the serving type. The network slice supports a plurality of SSTs. For example, the network slice supports a URLLC type, and the network slice further is referred to as a URLLC network slice. For another example, the network slice supports a MIoT type, and the network slice further is referred to as a MIoT network slice. For still another example, the network slice supports an eMBB type, and the network slice further is referred to as an eMBB network slice. For still another example, the network slice supports a V2X type, and the network slice further is referred to as a V2X network slice. eMBB, URLLC, MIoT, and V2X is understood as different SSTs. For ease of distinguishing, a type used below to distinguish a streaming service and an MTSI service that are supported by a terminal is referred to as a service type. A type used to distinguish a service supported by the network slice is referred to as a serving type. In some embodiments, one serving type is associated with one or more service types. For example, a V2X serving type is associated with the streaming service and the MTSI service.

Optionally, the S-NSSAI further includes slice differentiator (slice differentiator, SD) information. The SD information is understood as supplementary information of the SST. If the SST points to a plurality of network slices, the SD is assisted to correspond to a unique network slice.

When a network slice service is provided, a network side optimizes resource allocation of the network slice, to meet a QoE condition of a user. Similarly, before optimizing resource allocation of the network slice, the network side needs to perform QoE measurement collection on various types of services supported by the network slice. If a current procedure of collecting QoE measurement data is still used, the network side needs to send application layer measurement configuration information for a plurality of times. That is, the network side and the terminal need to perform this signaling interaction, and signaling overheads are large.

In addition, one service is implemented based on the plurality of network slices. If the current procedure of collecting QoE measurement data is still used, in some embodiments, a result of performing application layer measurement by the terminal on a network slice is unable to be obtained, and the network slice is unable to be optimized.

In some embodiments, an information processing method is discussed. The method is applied to a communication system shown in FIG. 2. The system shown in FIG. 2 includes a core network device, a first access network device, a second access network device, and a terminal. The first access network device or the second access network device communicates with the core network device. The first access network device communicates with the second access network device. The terminal communicates with the first access network device and/or the second access network device. The terminal simultaneously communicates with the first access network device and the second access network device. The communication is further referred to as multi-radio dual connectivity (multi-radio dual connectivity, MR-DC). In an MR-DC scenario, the first access network device is a secondary access network device. The second access network device is a master access network device. The first access network device and the second access network device is access network devices of different communication standards, or is access network devices of a same communication standard.

The access network device or a network device in some embodiments is an entity configured to receive or transmit a signal on a network side. The access network device is a device used by the terminal to access a wireless network, and is further referred to as a radio access network (radio access network, RAN) device. The access network device provides the terminal with functions such as radio resource management, quality of service management, data encryption, and data compression. For example, the access network device includes a base station (for example, an access point), is a device that communicates with a wireless terminal over an air interface in an access network through one or more cells, includes a radio network controller (radio network controller, RNC), a NodeB (NodeB, NB), a base station controller (base station controller, BSC), a base transceiver station (base transceiver station, BTS), a home NodeB (for example, a home evolved NodeB, or a home NodeB, HNB), a baseband unit (baseband unit, BBU), an active antenna unit (active antenna unit, AAU), a wireless fidelity (wireless fidelity, Wifi) access point (access point, AP), or the like, includes an evolved NodeB (NodeB, eNB, or e-NodeB, evolved NodeB) in a long term evolution (long term evolution, LTE) system or a long term evolution-advanced (LTE-Advanced, LTE-A) system, includes a next generation NodeB (next generation NodeB, gNB) in a 5th generation (5th generation, 5G) mobile communication technology new radio (new radio, NR) system, or includes a central unit (central unit, CU) and a distributed unit (distributed unit, DU), a central unit-control plane (central unit-control plane, CU-CP), a central unit-user plane (central unit-user plane, CU-UP), or the like in a cloud access network (cloud radio access network, Cloud RAN) system. This is not limited.

For example, the access network device is the gNB. The access network device provides a control plane protocol and function and/or a user plane protocol and function of new radio (NR) for the terminal device, and access a 5G core (5th generation core, 5GC) network. Alternatively, the access network device is an en-gNB. The access network device provides a control plane protocol and function and/or a user plane protocol and function of NR for the terminal device, and accesses a 4G core network, for example, an evolved packet core (evolved packet core, EPC) network. Alternatively, the access network device is the evolved NodeB. The access network device provides a control plane protocol and function and/or a user plane protocol and function of evolved universal terrestrial radio access (evolved universal terrestrial radio access, E-UTRA) for the terminal device, and accesses a 4G core network, for example, an EPC. Alternatively, the access network device is an ng-eNB. The access network device provides a control plane protocol and function and/or a user plane protocol and function of E-UTRA for the terminal, and accesses a 5G core (5GC) network. Alternatively, the access network device is the eNB. The access network device provides a control plane protocol and function and/or a user plane protocol and function of E-UTRA for the terminal, and accesses a 4G core network, for example, an EPC. Alternatively, the access network device is the CU. The access network device includes an RRC layer, a service data adaptation protocol (service data adaptation protocol, SDAP) layer, and a packet data convergence protocol (packet data convergence protocol, PDCP) layer of the gNB, or includes an RRC layer and a PDCP layer of an ng-eNB. Alternatively, the access network device is the DU. The access network device mainly includes a radio link control (radio link control, RLC) layer, a medium access control (medium access control, MAC) layer, and a physical layer of the gNB or an ng-eNB. Alternatively, the access network device is the CU-CP, namely, the central unit-control plane. The access network device includes an RRC layer in a gNB-CU or an ng-eNB-CU and a control plane in a PDCP layer. Alternatively, the access network device is the CU-UP, namely, the central unit-user plane. The access network device includes an SDAP layer in a gNB-CU or an ng-eNB-CU and a user plane in a PDCP layer.

The core network device in some embodiments, is an access and mobility management function (access and mobility management function, AMF) that is mainly responsible for functions such as access control, mobility management, attachment and detachment, and gateway selection. The core network device in some embodiments is not limited to the AMF. For example, the core network device is a session management function (session management function, SMF) that is mainly responsible for session management functions such as session setup, session modification, and session release.

The terminal in some embodiments further are referred to as the terminal device. The terminal device is an entity configured to receive or transmit a signal on a user side. The terminal is a device that provides voice and/or data connectivity for a user, for example, a handheld device having a wireless connection function, or a processing device connected to a wireless modem. The terminal communicates with a core network through the radio access network (radio access network, RAN), and exchange a voice and/or data with the RAN. The terminal includes user equipment (user equipment, UE), a wireless terminal device, a mobile terminal device, a device-to-device (device-to-device, D2D) communication terminal device, an unmanned aerial vehicle, a V2X terminal device, a machine-to-machine/machine-type communications (machine-to-machine/machine-type communications, M2M/MTC) terminal device, an IoT terminal device (for example, an electricity meter or a water meter), a subscriber unit (subscriber unit), a subscriber station (subscriber station), a mobile station (mobile station), a remote station (remote station), an access point (access point, AP), a remote terminal (remote terminal), an access terminal (access terminal), a user terminal (user terminal), a user agent (user agent), a user device (user device), or the like. For example, the terminal includes a mobile phone (or referred to as a “cellular” phone), a computer having a mobile terminal device, or a portable, pocket-sized, handheld, or computer built-in mobile apparatus. For example, the terminal is a device such as a personal communications service (personal communications service, PCS) phone, a cordless telephone set, a session initiation protocol (session initiation protocol, SIP) phone, a wireless local loop (wireless local loop, WLL) station, or a personal digital assistant (personal digital assistant, PDA). The terminal alternatively includes a limited device, for example, a device with low power consumption, a device with a limited storage capability, or a device with a limited computing capability. For example, the terminal includes an information sensing device such as a barcode, radio frequency identification (radio frequency identification, RFID), a sensor, a global positioning system (global positioning system, GPS), or a laser scanner.

The terminal is deployed on land (for example, deployed indoors, outdoors, or in a vehicle), is deployed on the water (for example, deployed on a ship), or is deployed in the air (for example, deployed on an airplane, a balloon, or a satellite). By way of example and not limitation, in some embodiments, the terminal alternatively is a wearable device. The wearable device further is referred to as a wearable intelligent device, an intelligent wearable device, or the like, and is a generic term for wearable devices that are developed by applying a wearable technology to intelligent implementations of daily wear, for example, glasses, gloves, watches, clothes, and shoes. The wearable device is a portable device that is directly worn on the body or integrated into clothes or an accessory of a user. The wearable device is a hardware device, but further implements a powerful function through software support, data exchange, and cloud interaction. In a broad sense, wearable intelligent devices include full-featured and large-sized devices that implements all or a part of functions without depending on smartphones, for example, smart watches or smart glasses, and include devices that focus on one type of application function and need to collaboratively work with other devices such as smartphones, for example, various smart bands, smart helmets, or smart jewelry for monitoring physical signs.

However, if the various terminals described above are located on a vehicle (for example, placed in the vehicle or installed in the vehicle), the terminals is considered as vehicle-mounted terminal devices. For example, the vehicle-mounted terminal devices are further referred to as on-board units (on-board units, OBUs).

The following describes in detail the technical solutions provided in some embodiments with reference to the accompanying drawings.

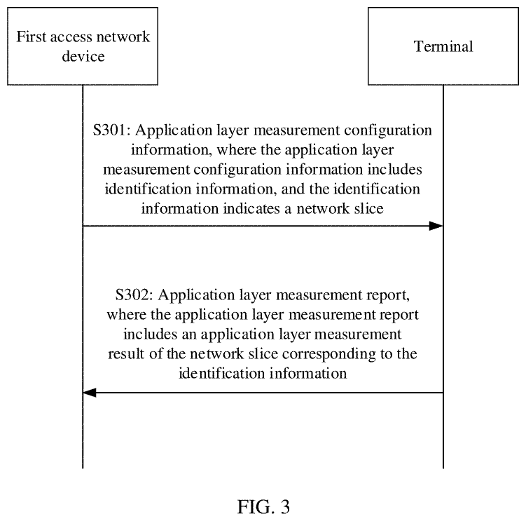

FIG. 3 is a schematic flowchart of an information processing method according to some embodiments. In the following descriptions, an example in which the method is applied to the communication system shown in FIG. 2 is used. In addition, the method is performed by at least two communication apparatuses, and the two communication apparatuses are, for example, a first communication apparatus and a second communication apparatus. The first communication apparatus is an access network device or a communication apparatus (for example, a chip system) that supports the access network device in implementing functions required for the method, or certainly is another communication apparatus. The second communication apparatus is a terminal, or is an apparatus (for example, a chip system) that supports the terminal in implementing functions required for the method, or certainly is another communication apparatus. Implementation forms of the first communication apparatus and the second communication apparatus are not limited in some embodiments. For example, the two communication apparatuses are implemented in a same form, for example, implemented in a form of a device; the two communication apparatuses are implemented in different forms, for example, the first communication apparatus is implemented in a form of a device, and the second communication apparatus is implemented in a form of the chip system; or the like. For ease of description, an example in which the method is performed by a first access network device and the terminal is used below. An example in which the first communication apparatus is the first access network device and the second communication apparatus is the terminal is used. A procedure of the information processing method according to this embodiment of this application is described as follows.

S301: The first access network device sends application layer measurement configuration information to the terminal. The application layer measurement configuration information includes identification information. The identification information indicates a network slice.

If the network slice needs to be optimized, the first access network device indicates the terminal to perform QoE measurement collection on the network slice. For example, the first access network device sends the application layer measurement configuration (application layer measurement configuration) information to the terminal. The application layer measurement configuration information includes the identification information indicating the network slice, to indicate the terminal to perform QoE measurement collection on the network slice indicated by the identification information.

For example, the identification information indicating the network slice includes S-NSSAI. In some embodiments, different values of the S-NSSAI respectively correspond to different serving types, for example, URLLC, MIoT, eMBB, and V2X. The application layer measurement configuration information sent by the first access network device to the terminal includes identification information of one network slice, or includes identification information of a plurality of network slices. The application layer measurement configuration information includes one piece of S-NSSAI, or includes a plurality of pieces of S-NSSAI. Each piece of S-NSSAI indicates one network slice. Because a serving type supported by one network slice is associated with a plurality of service types, when measuring one network slice, the terminal measures a plurality of services associated with the serving type supported by the network slice. In some embodiments, the application layer measurement configuration information is sent once, so that the terminal is indicated to perform application layer measurement on the network slice identified by the S-NSSAI included in the application layer measurement configuration information. That is, the terminal is indicated to measure the plurality of services associated with the serving type supported by the network slice. In this way, the terminal measures the plurality of services with less signaling interaction. Compared with the conventional technology, in some embodiments, overheads is reduced, and resources is saved.

In an alternative manner, the identification information of the network slice includes the URLLC, the MIoT, the eMBB, the V2X, or the like.

In a possible implementation, the first access network device sends the application layer measurement configuration information to the terminal by using radio resource control (radio resource control, RRC) signaling. For example, the application layer measurement configuration information is carried in an RRC connection reconfiguration message (which is further referred to as an RRC reconfiguration message) or an RRC connection resume message (which is further referred to as an RRC resume message). Alternatively, the first access network device sends the application layer measurement configuration information to the terminal by using another message. For example, the application layer measurement configuration information is carried in a measurement configuration application layer (MeasConfigAppLayer) message.

One network slice supports implementation of a plurality of service types. One service type alternatively is implemented based on a plurality of network slices. For example, there are a network slice 1, a network slice 2, a service type A, and a service type B. The network slice 1 supports implementation of the service type A and the service type B. The service type A alternatively is implemented based on the network slice 1 and the network slice 2. In this case, if a current procedure of collecting QoE measurement data on a network side is still used, in some embodiments, a result of performing application layer measurement by the terminal on a network slice is unable to be obtained, and the network slice is unable to be optimized.

Therefore, in some embodiments, the application layer measurement configuration information sent by the first access network device to the terminal device further includes a service type, and the application layer measurement configuration information indicates the terminal to perform QoE measurement collection on a serving type in the network slice. The foregoing example is still used, the service type A is a streaming service, and the service type B is an MTSI service. If the application layer measurement configuration information sent by the first access network device to the terminal device includes identification information and the service type B of the network slice 1, the first access network device indicates to perform QoE measurement collection on the MTSI service in the network slice 1. If the application layer measurement configuration information sent by the first access network device to the terminal device includes the identification information and the service type A of the network slice 1, the first access network device indicates to perform QoE measurement collection on the streaming service in the network slice 1. In other words, in some embodiments, that QoE measurement collection is performed on the network slice 1 that supports the service type A, so that a network slice is optimized.

S302: The terminal sends an application layer measurement report to the first access network device. The application layer measurement report includes an application layer measurement result of the network slice corresponding to the identification information.

The terminal receives the application layer measurement configuration information sent by the first access network device, and determines to perform QoE measurement collection on the network slice indicated by the identification information in the application layer measurement configuration information. Because the network slice supports one or more service types, QoE measurement collection on the network slice is considered as performing QoE measurement collection on the one or more service types in the network slice. QoE measurement collection performed by the terminal on the network slice includes measurement collection performed by the terminal on jitter duration, packet round trip time, and/or the like of the network slice. The application layer measurement result of the network slice includes a result of performing measurement by the terminal on the jitter duration, packet round trip time, and/or the like of the network slice.

After performing application layer measurement on the network slice, the terminal obtains the application layer measurement report (application layer measurement report), and sends the application layer measurement report to the first access network device. In some embodiments, the application layer measurement report includes the result of performing application layer measurement by the terminal on the network slice, for example, includes the result of performing measurement on the jitter duration and/or the packet round trip time. Alternatively, the application layer measurement report includes a result of performing application layer measurement by the terminal on the network slice and a service, for example, include a result of performing measurement by the terminal on a frame rate and/or jitter duration of a service in a network slice. In some embodiments, the application layer measurement report further includes the identification information indicating the network slice, to indicate an application layer measurement result of a network slice.

In some embodiments, the terminal sends the application layer measurement report to the first access network device by using RRC signaling. For example, the application layer measurement report is carried in an RRC connection reconfiguration complete message (which is further referred to as an RRC reconfiguration complete message) or an RRC connection resume complete message (which is further referred to as an RRC resume complete message). Alternatively, the terminal sends the application layer measurement report to the first access network device by using another message. For example, the application layer measurement report is carried in a measurement report application layer (MeasReportAppLayer) message.

Some terminals support QoE measurement collection on the network slice, and some terminals do not support QoE measurement collection on the network slice. To avoid a resource waste caused because the first access network device sends, to the terminal that does not support QoE measurement collection on the network slice, the application layer measurement configuration information that carries the identification information of the network slice, in another embodiment of this application, the terminal notifies the first access network device whether the terminal supports QoE measurement collection on the network slice.

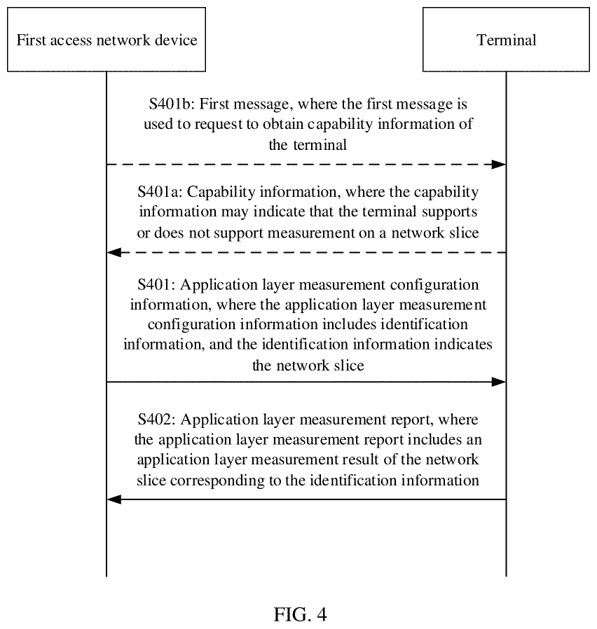

Refer to FIG. 4. S401a: A terminal sends capability information to a first access network device. The capability information indicates that the terminal supports or does not support QoE measurement collection on a network slice.

For example, the capability information includes indication information. The indication information indicates that the terminal supports or does not support QoE measurement collection performed on the network slice, or indicates that the terminal supports or does not support QoE measurement collection performed on the network slice and a service. If the indication information indicates that QoE measurement collection performed on the network slice is supported, the terminal has a capability of supporting QoE measurement collection on the network slice. If the indication information indicates that QoE measurement collection performed on the network slice and the service is supported, the terminal has a capability of supporting QoE measurement collection on the network slice.

The first access network device receives the capability information. If a determination is made that the capability indication information indicates that the terminal supports QoE measurement collection on the network slice, the first access network device sends, to the terminal, application layer measurement configuration information that carries identification information of the network slice. If the capability indication information indicates that the terminal does not support QoE measurement collection on the network slice, the application layer measurement configuration information sent by the first access network device to the terminal does not include the identification information of the network slice.

In some embodiments, the terminal actively sends the capability information to the first access network device. For example, the terminal periodically sends the capability information to the first access network device. Alternatively, the terminal sends the capability information to the first access network device when a capability changes. For example, when changing from supporting QoE measurement collection on a network slice 1 to supporting QoE measurement collection on a network slice 2, the terminal sends capability information to the first access network device, where the capability information indicates that the terminal has a capability of supporting QoE measurement collection on the network slice 2. The terminal actively sends the capability information of the terminal to the first access network device. The first access network device sends the application layer measurement configuration information based on the capability information of the terminal, to avoid as much as possible that the first access network device sends the application layer measurement configuration information to the terminal that does not support QoE measurement collection on the network slice, to reduce signaling overheads.

In some other embodiments, the terminal alternatively sends the capability information to the first access network device based on a condition of the first access network device, so that a case in which the terminal sends a large amount of capability information, and this increases load of the terminal is avoided. For example, before the terminal sends the capability information to the first access network device, the first access network device performs S401b. S401b: The first access network device sends a first message to the terminal. The first message is used to request to obtain the capability information of the terminal. In some embodiments, S401b is an optional step, and therefore is shown by using a dashed line in FIG. 4.

In some embodiments, after S401a, the first access network device performs S401, and the terminal performs S402. S401 is the same as S301, and S402 is the same as S302. Details are not described herein again. In some embodiments, S401a is an optional step, and therefore is shown by using a dashed line in FIG. 4.

In a possible implementation, the first access network device does not know whether to indicate the terminal to perform QoE measurement collection on the network slice or a service type. In this case, the application layer measurement configuration information sent by the first access network device to the terminal is notified by another network device such as a second access network device or a core network device.

For example, scenario 1: The terminal performs handover on an access network. The terminal is connected to the second access network device. The terminal is handed over from the second access network device to the first access network device. Before the terminal accesses the first access network device, the first access network device does not know network slices or service types that need to be measured by the terminal. However, the second access network device knows network slices or service types that are to be measured by the terminal. Therefore, the second access network device notifies the first access network device of the network slices or service types that need to be measured by the terminal.

Scenario 2: The terminal accesses a network. The terminal sets up a connection to the core network device. The core network device has been connected to the first access network device, but the first access network device has not set up a context of the terminal. In this scenario, the first access network device further does not know network slices or service types that need to be measured by the terminal. In this case, the core network device notifies the first access network device of the network slices or service types that need to be measured by the terminal.

Scenario 3: This scenario is a dual-connectivity scenario of the terminal. The terminal is connected to the first access network device and the second access network device. In this case, the first access network device is considered as a secondary access network device. Relatively, the second access network device is considered as a master access network device. If the second access network device wants to learn of an application layer measurement report of the terminal on the first access network device, the second access network device notifies the first access network device of network slices or service types that need to be measured by the terminal.

In the foregoing three example scenarios, the first access network device sends, under triggering of a network device, the application layer measurement configuration information to the terminal. In other words, the first access network device receives application layer measurement configuration information from another network device, and then sends the application layer measurement configuration information to the terminal.

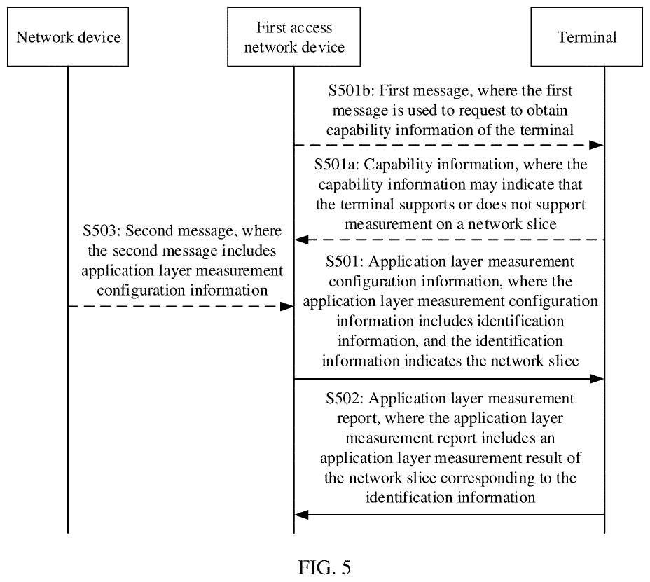

In some embodiments, refer to FIG. 5. S503: A network device sends a second message to a first access network device. The second message includes application layer measurement configuration information.

In some embodiments, the network device includes a second access network device, a core network device, or a network management device, for example, an operation administration and maintenance (operation administration and maintenance, OAM) system.

For example, if the network device is the core network device, the second message is an initial context setup request (initial context setup request) message that is used to request the first access network device to set up a context of a terminal. The initial context setup request message includes the application layer measurement configuration information. Alternatively, the second message is a handover request (handover request) message that is used to request the first access network device to prepare a resource for the terminal to access the first access network device. The handover request message includes the application layer measurement configuration information. Alternatively, the second message is a trace start (trace start) message sent by the core network device to the first access network device. The trace start message is used to initiate trace recording on the terminal. The trace start message includes the application layer measurement configuration information.

For example, if the network device is the second access network device, the second message is a retrieve terminal device context response (retrieve UE context response) message that is used to transmit the context of the terminal to the first access network device. The retrieve terminal device context response message includes the application layer measurement configuration information. Alternatively, the second message is the handover request (handover request) message that is used to request the first access network device to prepare the resource for the terminal to access the first access network device. The handover request message includes the application layer measurement configuration information. Alternatively, the second message is the trace start (trace start) message. The trace start message is used to initiate trace recording on the terminal. The trace start message includes the application layer measurement configuration information. Alternatively, the second message is a secondary node addition request (s-node addition request, or secondary gNB addition request) message that is used to request to prepare a resource for a dual-connectivity operation of the terminal. The secondary node addition request message includes the application layer measurement configuration information.

In some embodiments, after S503, the first access network device performs S501, and the terminal performs S502. S501 is the same as S301 and S401, and S502 is the same as S302 and S402. Details are not described herein again. In some embodiments, before S501, this embodiment of this application further includes S501a, or further includes S501a and S501b. S501a is the same as S401a, and S501b is the same as S401b. Details are not described herein again. In some embodiments, S503 is an optional step, and therefore is shown by using a dashed line in FIG. 5.

For example, in the foregoing scenario 3, if the terminal does not have the capability of supporting QoE measurement collection on the network slice, the network device directly sends the application layer measurement configuration information to the first access network device. This causes a resource waste. Therefore, the first access network device notifies the network device whether the terminal supports QoE measurement collection on the network slice. That is, the first access network device sends the capability information of the terminal to the network device. In some embodiments, the network device is the second access network device, the core network device, or another possible network device, for example, the network management device.

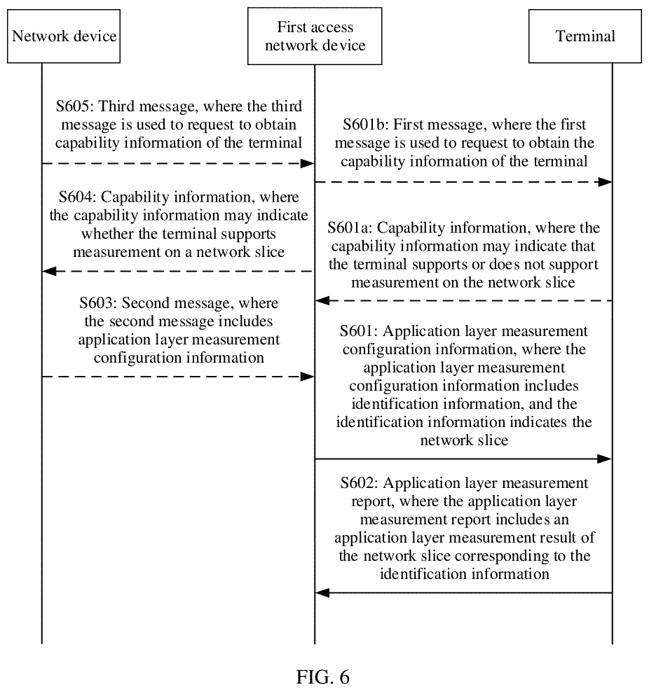

Refer to FIG. 6. S604: A first access network device sends capability information of a terminal to a network device.

In some embodiments, the first access network device actively sends the capability information of the terminal to the network device. For example, the first access network device periodically sends the capability information of the terminal to the network device. Alternatively, the first access network device sends the capability information of the terminal to the network device when a capability of the terminal changes, to avoid as much as possible that the network device sends application layer measurement configuration information to a first access network device accessed by a terminal that does not support QoE measurement collection on a network slice, to reduce signaling overheads.

In some other embodiments, the first access network device alternatively sends the capability information of the terminal to the network device based on a condition of the network device. This avoids a resource waste caused because the first access network device sends the capability information to the network device for a large quantity of times. For example, before the first access network device sends the capability information of the terminal to the network device, S605 is performed. S605: The network device sends a third message to the first access network device. The third message is used to request to obtain the capability information of the terminal.

Some embodiments further includes the foregoing S501a, S501b, S501, and S502. For ease of distinguishing, in FIG. 6, S601b is used to represent S501b, S601a is used to represent S501a, S601 is used to represent S501, and S602 is used to represent S502. In some embodiments, a sequence of S605, S601b, and S601a is not limited. S605 is performed after S601a and/or S601b, or is performed before S601a and/or S601b. Similarly, a sequence of S604, S601b, and S601a is not limited. S604 is performed after S601a and/or S601b, or is performed before S601a and/or S601b. In some embodiments, in FIG. 6, S601a, S601b, S603, S604, and S605 are optional steps, and therefore are shown by using dashed lines in FIG. 6.

In a possible scenario, a first access network device is a separate device. For example, the first access network device is a separate base station, and includes a CU and a DU. The CU is connected to the DU through an interface, for example, an F1 interface. Further, a function of the CU is implemented by one entity or is implemented by different entities. For example, the function of the CU is further divided. For example, a control plane (control panel, CP) is separated from a user plane (user panel, UP). That is, a CU-control plane (CU-CP) is separated from a CU-user plane (CU-UP). For example, the CU-CP and the CU-UP is implemented by different functional entities. The CU-CP and the CU-UP is coupled to the DU to jointly implement a function of the base station.

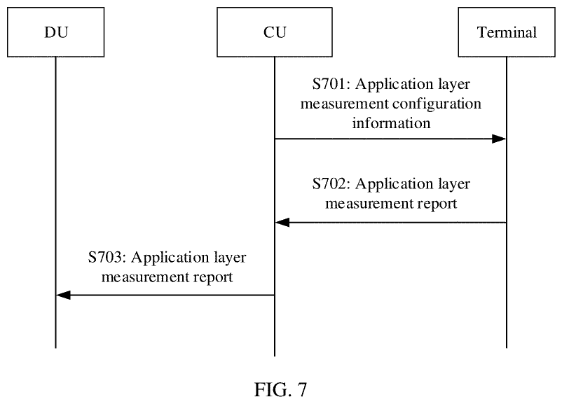

In this case, for a procedure of an information processing method according to some embodiments, refer to FIG. 7.

S701: A CU in a first access network device sends application layer measurement configuration information to a terminal.

S702: The CU in the first access network device receives an application layer measurement report from the terminal.

S703: The CU in the first access network device sends the application layer measurement report to a DU or a CU-UP in the first access network device.

The DU evaluates, based on the received application layer measurement report, whether a resource of a network slice needs to be optimized. If the resource of the network slice needs to be optimized, the DU optimizes the resource of the network slice. For example, the DU dynamically allocates or schedules the resource of the network slice. For example, the DU processes a buffer of the resource or a resource block of the network slice (for example, allocates more storage resources to the network slice), selects a radio bearer for performing data packet scheduling (for example, selects a radio bearer with a higher priority to transmit a data packet in the network slice), adjusts a transmit power level or a receive power level required for sending the data packet in the network slice, and manages a resource block used in the network slice (for example, allocates the resource block to the data packet in the network slice, so that the resource block is used to transmit the data packet in the network slice).

In some embodiments, if the CU includes a CU-CP and the CU-UP, the foregoing S701 is that the CU-CP in the first access network device sends the application layer measurement configuration information to the terminal; S702 is that the CU-CP in the first access network device receives the application layer measurement report from the terminal; and S703 is that the CU-CP in the first access network device sends the application layer measurement report to the DU or the CU-UP in the first access network device. Correspondingly, the DU/CU-UP evaluates, based on the received application layer measurement report, whether the resource of the network slice needs to be optimized. If the resource of the network slice needs to be optimized, the DU/CU-UP optimizes the resource of the network slice.

In some embodiments, a difference between FIG. 7 and FIG. 3 lies in that the first access network device is the separate device. The first access network device includes the CU and the DU, or includes the CU-CP, the CU-UP, and the DU. For detailed information exchange with the terminal, refer to the embodiment in FIG. 3. For example, the application layer measurement configuration information sent by the CU or the CU-CP to the terminal further includes identification information indicating the network slice. For another example, the terminal sends capability information of the terminal to the CU or the CU-CP. The CU or the CU-CP sends the terminal a message, for example, the first message, used to request to obtain the capability information of the terminal. Details are not described herein again.

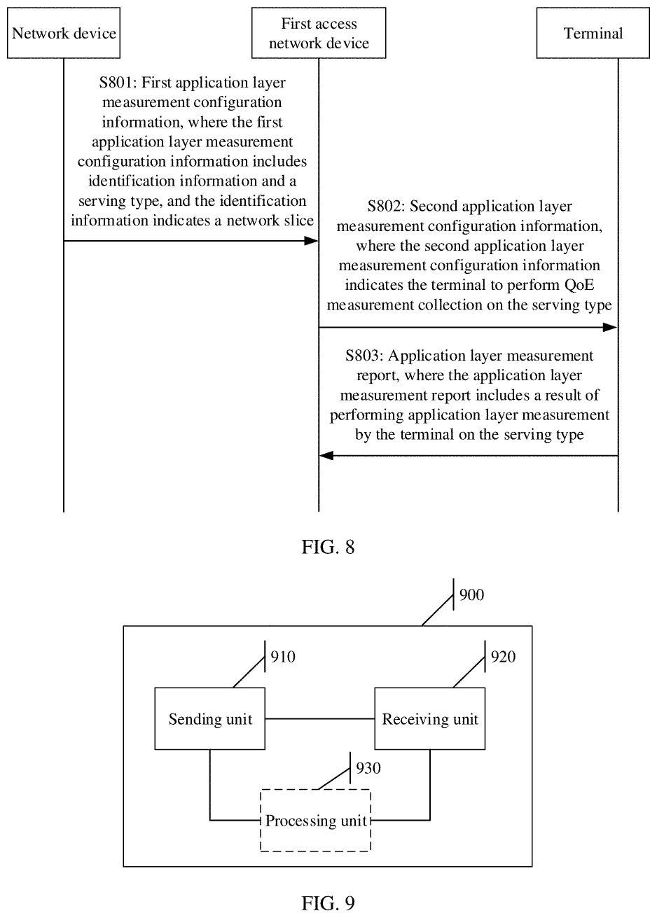

FIG. 8 is a schematic flowchart of another information processing method according to some embodiments. In the following descriptions, an example in which the method is applied to the communication system shown in FIG. 2 is used. In addition, the method is performed by at least three communication apparatuses, and the three communication apparatuses are, for example, a first communication apparatus, a second communication apparatus, and a third communication apparatus. The first communication apparatus is an access network device or a communication apparatus (for example, a chip system) that supports the access network device in implementing functions required for the method, or certainly is another communication apparatus. Alternatively, the second communication apparatus is a network device or a communication apparatus (for example, a chip system) that supports the network device in implementing functions required for the method, or certainly is another communication apparatus. The third communication apparatus is a terminal, or is an apparatus (for example, a chip system) that supports the terminal in implementing functions required for the method, or certainly is another communication apparatus. Implementation forms of the first communication apparatus, the second communication apparatus, and the third communication apparatus are not limited in some embodiments. For example, the three communication apparatuses is implemented in a same form, for example, implemented in a form of a device; the three communication apparatuses is implemented in different forms, for example, the first communication apparatus is implemented in a form of the device, the second communication apparatus is implemented in a form of the chip system, and the third communication apparatus is implemented in a form of the chip system; or the like For ease of description, an example in which the method is performed by a first access network device and the terminal is used below. An example in which the first communication apparatus is the first access network device, the second communication apparatus is the network device, and the third communication apparatus is the terminal is used. The network device includes a core network device, for example, a second access network device, or a network management device. A procedure of the information processing method according to this embodiment of this application is described as follows.

S801: The network device sends first application layer measurement configuration information to the first access network device. The first application layer measurement configuration information includes identification information and a service type. The identification information indicates a network slice.

Similar to the foregoing embodiments in FIG. 3 to FIG. 6, the identification information is S-NSSAI. In some embodiments, the first application layer measurement configuration information includes one piece of S-NSSAI, or includes a plurality of pieces of S-NSSAI. In addition, the first application layer measurement configuration information further includes the service type, and the first application layer measurement configuration information indicates to perform QoE measurement collection on the service type in the network slice indicated by the identification information.

In some embodiments, the network device is the core network device. The first application layer measurement configuration information is carried in an initial context setup request message, a handover request message, a trace start message, or the like. The network device is the second access network device. The first application layer measurement configuration information is carried in a retrieve terminal device context response message, the handover request message, the trace start message, a secondary node addition request message, or the like. For details, refer to the related descriptions in the foregoing embodiments in FIG. 3 to FIG. 6. Details are not described herein again.

S802: The first access network device sends second application layer measurement configuration information to the terminal. The second application layer measurement configuration information indicates the terminal to perform QoE measurement collection on the service type.

If the network slice indicated by the identification information included in the first application layer measurement configuration information supports one service type, after receiving the first application layer measurement configuration information sent by a network device, the first access network device sends the second application layer measurement configuration information to the terminal. A difference from the foregoing embodiments in FIG. 3 to FIG. 6 lies in that the second application layer measurement configuration information includes the service type, and does not include the S-NSSAI, and the second application layer measurement configuration information indicates a service on which the terminal performs application layer measurement. In other words, the first access network device obtains an application layer measurement result related to the network slice without notifying the terminal of information about a network slice on which application layer measurement is performed.

In some embodiments, the first access network device sends the second application layer measurement configuration information to the terminal by using RRC signaling. For example, the second application layer measurement configuration information is carried in an RRC connection reconfiguration message (which further is referred to as an RRC reconfiguration message for short) or an RRC connection resume message (which further is referred to as an RRC resume message for short). Alternatively, the second application layer measurement configuration information is carried in a measurement configuration application layer message.

S803: The terminal sends an application layer measurement report to the first access network device. The application layer measurement report includes a result of performing application layer measurement by the terminal on the service type.

The terminal receives the second application layer measurement configuration information, starts an application layer measurement procedure, and obtains the result of performing application layer measurement on the service type. Then, the terminal sends the application layer measurement report to the first access network device. The application layer measurement report includes the result of performing application layer measurement by the terminal on the service type. In some embodiments, the application layer measurement report includes the service type, and the application layer measurement report indicates an application layer measurement result of a service type.

In some embodiments, the terminal sends the application layer measurement report to the first access network device by using RRC signaling. For example, the application layer measurement report is carried in an RRC connection reconfiguration complete message (which further is referred to as an RRC reconfiguration complete message for short) or an RRC connection resume complete message (which further is referred to as an RRC resume complete message for short). Alternatively, the application layer measurement report is carried in a measurement report application layer message.

After receiving the application layer measurement report sent by the terminal device, the first access network device adds identification information, for example, the S-NSSAI, corresponding to the application layer measurement report, and sends the S-NSSAI and the application layer measurement report to an application layer measurement report server, for example, a trace collection entity (trace collection entity, TCE). The TCE optimizes, based on the application layer measurement report and the S-NSSAI, a network slice indicated by the S-NSSAI.

In some embodiments, if the first access network device is a separate device, a CU/CU-CP in the first access network device sends the application layer measurement report and the S-NSSAI to a DU/CU-UP.

In some embodiments, the application layer measurement configuration information sent by a network side to the terminal includes the identification information indicating the network slice. Because one network slice supports a plurality of service types, and one serving type is associated with the plurality of service types, the network side needs to send the application layer measurement configuration information once, so that the terminal performs application layer measurement on a plurality of services. This reduces a quantity of times of information exchange between the network side and the terminal, and reduces overheads.

In the foregoing embodiments provided in this application, the methods provided in some embodiments are separately described from perspectives of interaction between the first access network device, the network device, and the terminal device. To implement functions in the foregoing methods provided in some embodiments, each of the first access network device, the network device, and the terminal device includes a hardware structure and/or a software module, and implement the foregoing functions in a form of the hardware structure, the software module, or a combination of the hardware structure and the software module. Whether a function in the foregoing functions is performed by using a hardware structure, a software module, or a combination of the hardware structure and the software module depends on an application and a design constraint of the technical solutions.

With reference to the accompanying drawings, the following describes apparatuses configured to implement the foregoing methods in some embodiments. Therefore, the foregoing content is used in the following embodiments. Repeated content is not described again.

FIG. 9 is a schematic block diagram of a communication apparatus 900 according to some embodiments. The communication apparatus 900 correspondingly implements the functions or steps implemented by the first access network device, the network device, or the terminal in the foregoing method embodiments. The communication apparatus includes a sending unit 910 and a receiving unit 920, and optionally, further includes a processing unit 930. The processing unit 930 is not indispensable, and therefore is shown by using a dashed line in FIG. 9. Optionally, the communication apparatus further includes a storage unit. The storage unit is configured to store instructions (code or a program) and/or data. The sending unit 910, the receiving unit 920, and the processing unit 930 is coupled to the storage unit. For example, the processing unit 930 reads the instructions (the code or the program) and/or the data in the storage unit, to implement corresponding methods. The foregoing units are disposed independently, or are partially or completely integrated.

In some possible implementations, the communication apparatus 900 correspondingly implements behavior and functions of the first access network device in the foregoing method embodiments. For example, the communication apparatus 900 is a first access network device, or is a component (for example, a chip or a circuit) used in the first access network device. The sending unit 910 and the receiving unit 920 is configured to perform receiving or sending operations performed by the first access network device in the embodiment shown in FIG. 3, for example, S301 and S302 in the embodiment shown in FIG. 3, and/or configured to support another process of the technology described in some embodiments. The processing unit 930 is configured to perform operations, other than the receiving and sending operations, performed by the first access network device in the embodiment shown in FIG. 3, and/or configured to support another process of the technology described in some embodiments. Alternatively, the sending unit 910 and the receiving unit 920 is configured to perform receiving or sending operations performed by the first access network device in the embodiment shown in FIG. 4, for example, S401a, S401b, S401, and S402 in the embodiment shown in FIG. 4, and/or configured to support another process of the technology described in some embodiments. The processing unit 930 is configured to perform operations, other than the receiving and sending operations, performed by the first access network device in the embodiment shown in FIG. 4, and/or configured to support another process of the technology described in some embodiments. Alternatively, the sending unit 910 and the receiving unit 920 is configured to perform receiving or sending operations performed by the first access network device in the embodiment shown in FIG. 5, for example, S501a, S501b, S501, S502, and S503 in the embodiment shown in FIG. 5, and/or configured to support another process of the technology described in some embodiments. The processing unit 930 is configured to perform operations, other than the receiving and sending operations, performed by the first access network device in the embodiment shown in FIG. 5, and/or configured to support another process of the technology described in some embodiments. Alternatively, the sending unit 910 and the receiving unit 920 is configured to perform receiving or sending operations performed by the first access network device in the embodiment shown in FIG. 6, for example, S601a, S601b, S601, S602, S603, S604, and S605 in the embodiment shown in FIG. 6, and/or configured to support another process of the technology described in some embodiments. The processing unit 930 is configured to perform operations, other than the receiving and sending operations, performed by the first access network device in the embodiment shown in FIG. 6, and/or configured to support another process of the technology described in some embodiments. Alternatively, the sending unit 910 and the receiving unit 920 is configured to perform all receiving or sending operations performed by the first access network device in the embodiment shown in FIG. 7, for example, S701, S702, and S703 in the embodiment shown in FIG. 7, and/or configured to support another process of the technology described in some embodiments. The processing unit 930 is configured to perform operations, other than the receiving and sending operations, performed by the first access network device in the embodiment shown in FIG. 7, and/or configured to support another process of the technology described in some embodiments. Alternatively, the sending unit 910 and the receiving unit 920 is configured to perform receiving or sending operations performed by the first access network device in the embodiment shown in FIG. 8, for example, S801, S802, and S803 in the embodiment shown in FIG. 8, and/or configured to support another process of the technology described in some embodiments. The processing unit 930 is configured to perform operations, other than the receiving and sending operations, performed by the first access network device in the embodiment shown in FIG. 8, and/or configured to support another process of the technology described in some embodiments.

In some embodiments, the sending unit 910 is configured to send application layer measurement configuration information to a terminal. The application layer measurement configuration information includes identification information. The identification information indicates a network slice. The receiving unit 920 is configured to receive an application layer measurement report from the terminal. The application layer measurement report includes an application layer measurement result of the network slice.

In an optional implementation, the identification information includes S-NSSAI.

In an optional implementation, the application layer measurement configuration information further includes a service type. The application layer measurement configuration information indicates to perform QoE measurement collection on the service type in the network slice.

In an optional implementation, the receiving unit 920 is further configured to receive a first message from a network device. The first message includes the application layer measurement configuration information.

In an optional implementation, the receiving unit 920 is further configured to receive capability information from the terminal. The capability information indicates that the terminal supports QoE measurement collection on the network slice.

In an optional implementation, before the communication apparatus 900 receives the capability information from the terminal, the sending unit 910 is further configured to send a second message to the terminal. The second message is used to request to obtain the capability information of the terminal.

In an optional implementation, the sending unit 910 is further configured to send the capability information of the terminal to the network device. The capability information indicates that the terminal supports QoE measurement collection.

In an optional implementation, before the communication apparatus 900 sends the capability information of the terminal to the network device, the receiving unit 920 is further configured to receive a third message from the network device. The third message is used to request to obtain the capability information of the terminal.

In an optional implementation, the communication apparatus 900 includes a CU and a DU, and both the CU and the DU includes the sending unit and the receiving unit. That the sending unit 910 sends application layer measurement configuration information to a terminal is that the CU sends the application layer measurement configuration information to the terminal. In other words, the sending unit 910 included in the CU sends the application layer measurement configuration information to the terminal.

In an optional implementation, the communication apparatus 900 includes the CU and the DU. That the receiving unit 920 receives an application layer measurement report from the terminal is that the CU receives the application layer measurement report from the terminal. In other words, the receiving unit 920 included in the DU receives the application layer measurement report from the terminal.

In a possible implementation, the sending unit 910 in the CU sends the application layer measurement report of the terminal to the receiving unit 920 in the DU.

In some other embodiments, the receiving unit 920 is configured to receive first application layer measurement configuration information from a network device. The first application layer measurement configuration information includes identification information and a service type. The identification information indicates a network slice. The sending unit 910 is configured to send second application layer measurement configuration information to a terminal. The second application layer measurement configuration information indicates the terminal to perform QoE measurement collection on the service type. The receiving unit 920 is further configured to receive an application layer measurement report from the terminal. The application layer measurement report includes a result of performing application layer measurement by the terminal on the service type.

In some embodiments, the processing unit 930 is implemented by a processor or a processor-related circuit component. The sending unit 910 and the receiving unit 920 is implemented by a transceiver, a transceiver-related circuit component, or a communication interface.

In some possible implementations, the communication apparatus 900 correspondingly implements behavior and functions of the terminal in the foregoing method embodiments. For example, the communication apparatus 900 is a terminal, or is a component (for example, a chip or a circuit) used in the terminal. The sending unit 910 and the receiving unit 920 is configured to perform receiving or sending operations performed by the terminal in the embodiment shown in FIG. 3, for example, S301 and S302 in the embodiment shown in FIG. 3, and/or configured to support another process of the technology described in some embodiments. The processing unit 930 is configured to perform operations, other than the receiving and sending operations, performed by the terminal in the embodiment shown in FIG. 3, and/or configured to support another process of the technology described in some embodiments. Alternatively, the sending unit 910 and the receiving unit 920 is configured to perform receiving or sending operations performed by the terminal in the embodiment shown in FIG. 4, for example, S401a, S401b, S401, and S402 in the embodiment shown in FIG. 4, and/or configured to support another process of the technology described in some embodiments. The processing unit 930 is configured to perform operations, other than the receiving and sending operations, performed by the terminal in the embodiment shown in FIG. 4, and/or configured to support another process of the technology described in some embodiments. Alternatively, the sending unit 910 and the receiving unit 920 is configured to perform receiving or sending operations performed by the terminal in the embodiment shown in FIG. 5, for example, S501a, S501b, S501, and S502 in the embodiment shown in FIG. 5, and/or configured to support another process of the technology described in some embodiments. The processing unit 930 is configured to perform operations, other than the receiving and sending operations, performed by the terminal in the embodiment shown in FIG. 5, and/or configured to support another process of the technology described in some embodiments. Alternatively, the sending unit 910 and the receiving unit 920 is configured to perform receiving or sending operations performed by the terminal in the embodiment shown in FIG. 6, for example, S601a, S601b, S601, and S602 in the embodiment shown in FIG. 6, and/or configured to support another process of the technology described in some embodiments. The processing unit 930 is configured to perform operations, other than the receiving and sending operations, performed by the terminal in the embodiment shown in FIG. 6, and/or configured to support another process of the technology described in some embodiments. Alternatively, the sending unit 910 and the receiving unit 920 is configured to perform receiving or sending operations performed by the terminal in the embodiment shown in FIG. 7, for example, S701 and S702 in the embodiment shown in FIG. 7, and/or configured to support another process of the technology described in some embodiments. The processing unit 930 is configured to perform operations, other than the receiving and sending operations, performed by the terminal in the embodiment shown in FIG. 7, and/or configured to support another process of the technology described in some embodiments. Alternatively, the sending unit 910 and the receiving unit 920 is configured to perform receiving or sending operations performed by the terminal in the embodiment shown in FIG. 8, for example, S802 and S803 in the embodiment shown in FIG. 8, and/or configured to support another process of the technology described in some embodiments. The processing unit 930 is configured to perform operations, other than the receiving and sending operations, performed by the terminal in the embodiment shown in FIG. 8, and/or configured to support another process of the technology described in some embodiments.

In some embodiments, the receiving unit 920 is configured to receive application layer measurement configuration information from a first access network device. The application layer measurement configuration information includes identification information. The identification information indicates a network slice. The sending unit 910 is configured to send an application layer measurement report to the first access network device. The application layer measurement report includes an application layer measurement result of the network slice.

In an optional implementation, the identification information includes S-NSSAI.

In an optional implementation, the application layer measurement configuration information further includes a service type. The application layer measurement configuration information indicates to perform QoE measurement collection on the service type in the network slice.

In an optional implementation, the sending unit 910 is further configured to send capability information to the first access network device. The capability information indicates that the terminal supports quality of experience measurement collection on the network slice.

In an optional implementation, before the communication apparatus 900 sends the capability information to the first access network device, the receiving unit 920 is further configured to receive a second message from the first access network device. The second message is used to request to obtain the capability information of the terminal.

In some embodiments, the processing unit 930 is implemented by a processor or a processor-related circuit component. The sending unit 910 and the receiving unit 920 is implemented by a transceiver or a transceiver-related circuit component.

In some possible implementations, the communication apparatus 900 correspondingly implements behavior and functions of the network device in the foregoing method embodiments. For example, the communication apparatus 900 is a network device, or is a component (for example, a chip or a circuit) used in the network device. The sending unit 910 and the receiving unit 920 is configured to perform receiving or sending operations performed by the network device in the embodiment shown in FIG. 5, for example, S503 in the embodiment shown in FIG. 5, and/or configured to support another process of the technology described in some embodiments. The processing unit 930 is configured to perform operations, other than the receiving and sending operations, performed by the network device in the embodiment shown in FIG. 5, and/or configured to support another process of the technology described in some embodiments. Alternatively, the sending unit 910 and the receiving unit 920 is configured to perform receiving or sending operations performed by the network device in the embodiment shown in FIG. 6, for example, S603, S604, and S605 in the embodiment shown in FIG. 6, and/or configured to support another process of the technology described in some embodiments. The processing unit 930 is configured to perform operations, other than the receiving and sending operations, performed by the network device in the embodiment shown in FIG. 6, and/or configured to support another process of the technology described in some embodiments. Alternatively, the sending unit 910 and the receiving unit 920 is configured to perform receiving or sending operations performed by the network device in the embodiment shown in FIG. 8, for example, S801 in the embodiment shown in FIG. 8, and/or configured to support another process of the technology described in some embodiments. The processing unit 930 is configured to perform operations, other than the receiving and sending operations, performed by the network device in the embodiment shown in FIG. 8, and/or configured to support another process of the technology described in some embodiments.

In some embodiments, the sending unit 910 sends a first message to a first access network device. The first message includes application layer measurement configuration information. In some embodiments, before the sending unit 910 sends the first message to the first access network device, the processing unit 930 determines the first message.

In an optional implementation, the receiving unit 920 is configured to receive capability information of a terminal from the first access network device. The capability information indicates that the terminal supports QoE measurement collection on a network slice.

In an optional implementation, before the communication apparatus 900 receives the capability information of the terminal from the first access network device, the sending unit 910 is further configured to send a second message to the first access network device. The second message is used to request to obtain the capability information of the terminal.

In some other embodiments, the sending unit 910 sends first application layer measurement configuration information to a first access network device. The first application layer measurement configuration information includes identification information and a service type. The identification information indicates a network slice. In some embodiments, before the sending unit 910 sends the first application layer measurement configuration information to the first access network device, the processing unit 930 determines the first application layer measurement configuration information.

In some embodiments, the processing unit 930 is implemented by a processor or a processor-related circuit component. The sending unit 910 and the receiving unit 920 is implemented by a transceiver or a transceiver-related circuit component.

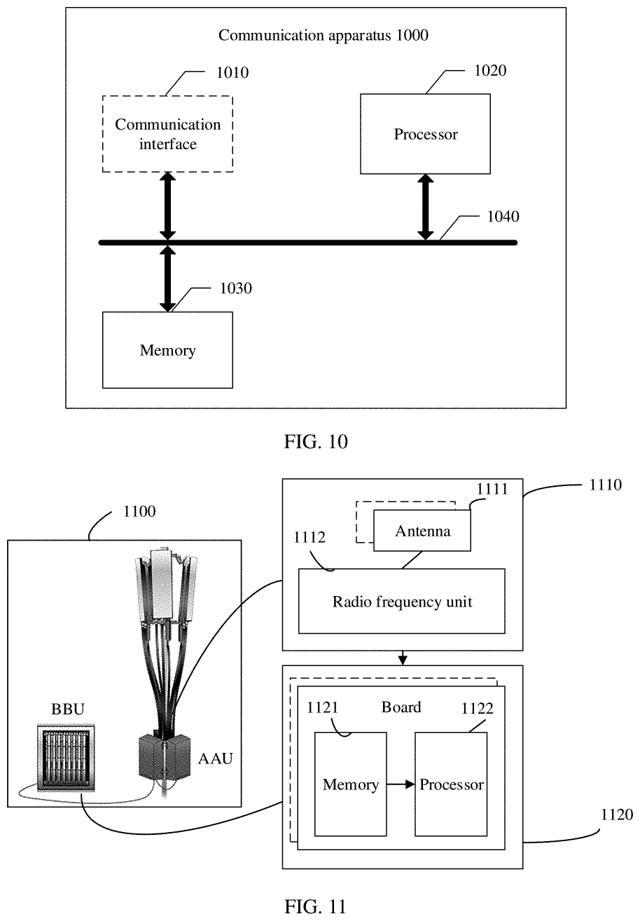

FIG. 10 shows a communication apparatus 1000 according to some embodiments. The communication apparatus 1000 is a terminal device that implements functions of the terminal in the methods provided in some embodiments. Alternatively, the communication apparatus 1000 is a network device that implements functions of the first access network device or the network device in the methods provided in some embodiments. Alternatively, the communication apparatus 1000 is an apparatus that supports the terminal in implementing corresponding functions in the methods provided in some embodiments, or an apparatus that supports the first access network device or the network device in implementing corresponding functions in the methods provided in some embodiments. The communication apparatus 1000 is a chip system. In some embodiments, the chip system includes a chip, or includes a chip and another discrete component.

In some embodiments, the communication apparatus 1000 includes a communication interface 1010, configured to communicate with another device through a transmission medium, so that a device in the communication apparatus 1000 communicates with the other device. For example, when the communication apparatus is the terminal, the other device is the first access network device or the network device. Alternatively, when the communication apparatus is the first access network device, the other device is the terminal or the network device. A processor 1020 sends and receive data by using the communication interface 1010.

The communication apparatus 1000 further includes at least one processor 1020, configured to implement or support the communication apparatus 1000 in implementing the functions of the first access network device, the network device, or the terminal in the methods provided in some embodiments.

For example, the communication apparatus 1000 correspondingly implements behavior and functions of the first access network device in the foregoing method embodiments. The communication interface 1010 is configured to perform receiving or sending operations performed by the first access network device in the embodiment shown in FIG. 3, for example, S301 and S302 in the embodiment shown in FIG. 3, and/or configured to support another process of the technology described in some embodiments. The processor 1020 is configured to perform operations, other than the receiving and sending operations, performed by the first access network device in the embodiment shown in FIG. 3, and/or configured to support another process of the technology described in some embodiments. Alternatively, the communication interface 1010 is configured to perform receiving or sending operations performed by the first access network device in the embodiment shown in FIG. 4, for example, S401a, S401b, S401, and S402 in the embodiment shown in FIG. 4, and/or configured to support another process of the technology described in some embodiments. The processor 1020 is configured to perform operations, other than the receiving and sending operations, performed by the first access network device in the embodiment shown in FIG. 4, and/or configured to support another process of the technology described in some embodiments. Alternatively, the communication interface 1010 is configured to perform receiving or sending operations performed by the first access network device in the embodiment shown in FIG. 5, for example, S501a, S501b, S501, S502, and S503 in the embodiment shown in FIG. 5, and/or configured to support another process of the technology described in some embodiments. The processor 1020 is configured to perform operations, other than the receiving and sending operations, performed by the first access network device in the embodiment shown in FIG. 5, and/or configured to support another process of the technology described in some embodiments. Alternatively, the communication interface 1010 is configured to perform receiving or sending operations performed by the first access network device in the embodiment shown in FIG. 6, for example, S601a, S601b, S601, S602, S603, S604, and S605 in the embodiment shown in FIG. 6, and/or configured to support another process of the technology described in some embodiments. The processor 1020 is configured to perform operations, other than the receiving and sending operations, performed by the first access network device in the embodiment shown in FIG. 6, and/or configured to support another process of the technology described in some embodiments. Alternatively, the communication interface 1010 is configured to perform receiving or sending operations performed by the first access network device in the embodiment shown in FIG. 7, for example, S701, S702, and S703 in the embodiment shown in FIG. 7, and/or configured to support another process of the technology described in some embodiments. The processor 1020 is configured to perform operations, other than the receiving and sending operations, performed by the first access network device in the embodiment shown in FIG. 7, and/or configured to support another process of the technology described in some embodiments. Alternatively, the communication interface 1010 is configured to perform receiving or sending operations performed by the first access network device in the embodiment shown in FIG. 8, for example, S801, S802, and S803 in the embodiment shown in FIG. 8, and/or configured to support another process of the technology described in some embodiments. The processor 1020 is configured to perform operations, other than the receiving and sending operations, performed by the first access network device in the embodiment shown in FIG. 8, and/or configured to support another process of the technology described in some embodiments.

For example, the communication apparatus 1000 correspondingly implements behavior and functions of the terminal in the foregoing method embodiments. The communication interface 1010 is configured to perform receiving or sending operations performed by the terminal in the embodiment shown in FIG. 3, for example, S301 and S302 in the embodiment shown in FIG. 3, and/or configured to support another process of the technology described in some embodiments. The processor 1020 is configured to perform operations, other than the receiving and sending operations, performed by the terminal in the embodiment shown in FIG. 3, and/or configured to support another process of the technology described in some embodiments. Alternatively, the communication interface 1010 is configured to perform receiving or sending operations performed by the terminal in the embodiment shown in FIG. 4, for example, S401a, S401b, S401, and S402 in the embodiment shown in FIG. 4, and/or configured to support another process of the technology described in some embodiments. The processor 1020 is configured to perform operations, other than the receiving and sending operations, performed by the terminal in the embodiment shown in FIG. 4, and/or configured to support another process of the technology described in some embodiments. Alternatively, the communication interface 1010 is configured to perform receiving or sending operations performed by the terminal in the embodiment shown in FIG. 5, for example, S501a, S501b, S501, and S502 in the embodiment shown in FIG. 5, and/or configured to support another process of the technology described in some embodiments. The processing unit 930 is configured to perform operations, other than the receiving and sending operations, performed by the terminal in the embodiment shown in FIG. 5, and/or configured to support another process of the technology described in some embodiments. Alternatively, the communication interface 1010 is configured to perform receiving or sending operations performed by the terminal in the embodiment shown in FIG. 6, for example, S601a, S601b, S601, and S602 in the embodiment shown in FIG. 6, and/or configured to support another process of the technology described in some embodiments. The processor 1020 is configured to perform operations, other than the receiving and sending operations, performed by the terminal in the embodiment shown in FIG. 6, and/or configured to support another process of the technology described in some embodiments. Alternatively, the communication interface 1010 is configured to perform receiving or sending operations performed by the terminal in the embodiment shown in FIG. 7, for example, S701 and S702 in the embodiment shown in FIG. 7, and/or configured to support another process of the technology described in some embodiments. The processor 1020 is configured to perform operations, other than the receiving and sending operations, performed by the terminal in the embodiment shown in FIG. 7, and/or configured to support another process of the technology described in some embodiments. Alternatively, the communication interface 1010 is configured to perform receiving or sending operations performed by the terminal in the embodiment shown in FIG. 8, for example, S802 and S803 in the embodiment shown in FIG. 8, and/or configured to support another process of the technology described in some embodiments. The processor 1020 is configured to perform operations, other than the receiving and sending operations, performed by the terminal in the embodiment shown in FIG. 8, and/or configured to support another process of the technology described in some embodiments.

For example, the communication apparatus 1000 correspondingly implements behavior and functions of the network device in the foregoing method embodiments. The communication interface 1010 is configured to perform receiving or sending operations performed by the network device in the embodiment shown in FIG. 5, for example, S503 in the embodiment shown in FIG. 5, and/or configured to support another process of the technology described in some embodiments. The processor 1020 is configured to perform operations, other than the receiving and sending operations, performed by the network device in the embodiment shown in FIG. 5, and/or configured to support another process of the technology described in some embodiments. Alternatively, the communication interface 1010 is configured to perform receiving or sending operations performed by the network device in the embodiment shown in FIG. 6, for example, S603, S604, and S605 in the embodiment shown in FIG. 6, and/or configured to support another process of the technology described in some embodiments. The processor 1020 is configured to perform operations, other than the receiving and sending operations, performed by the network device in the embodiment shown in FIG. 6, and/or configured to support another process of the technology described in some embodiments. Alternatively, the communication interface 1010 is configured to perform receiving or sending operations performed by the network device in the embodiment shown in FIG. 8, for example, S801 in the embodiment shown in FIG. 8, and/or configured to support another process of the technology described in some embodiments. The processor 1020 is configured to perform operations, other than the receiving and sending operations, performed by the network device in the embodiment shown in FIG. 8, and/or configured to support another process of the technology described in some embodiments.

In some other embodiments, the communication apparatus 1000 further includes at least one memory 1030, configured to store program instructions and/or data. The memory 1030 is coupled to the processor 1020. The coupling in some embodiments is an indirect coupling or a communication connection between apparatuses, units, or modules in an electrical form, a mechanical form, or another form, and is used for information exchange between the apparatuses, the units, or the modules. The processor 1020 cooperates with the memory 1030. The processor 1020 executes the program instructions and/or the data stored in the memory 1030, so that the communication apparatus 1000 implements corresponding methods. At least one of the at least one memory is included in the processor.

In still some other embodiments, the communication interface 1010 is specifically a transceiver. In other words, the communication apparatus 1000 includes the processor 1020, at least one memory 1030, and the transceiver. In some embodiments, the sending unit 910, the receiving unit 920, and the communication interface 1010 is transceivers.

A connection medium between the communication interface 1010, the processor 1020, and the memory 1030 is not limited in some embodiments. In some embodiments, the memory 1030, the processor 1020, and the communication interface 1010 are connected to each other through a bus 1040 in FIG. 10. The bus is represented by using a bold line in FIG. 10. A connection manner between other components is an example for descriptions, and is not limited thereto. The bus is classified into an address bus, a data bus, a control bus, and the like. For ease of representation, one bold line is used to represent the bus in FIG. 10, but this does not mean that there is one bus or one type of bus.

In some embodiments, the processor 1020 is a general-purpose processor, a digital signal processor, an application-specific integrated circuit, a field programmable gate array or another programmable logic device, a discrete gate or transistor logic device, or a discrete hardware component, and implements or perform the methods, steps, and logical block diagrams disclosed in some embodiments. The general-purpose processor is a microprocessor or any conventional processor or the like. The steps of the methods disclosed with reference to some embodiments are directly performed by a hardware processor, or are performed by using a combination of hardware in the processor and a software module.

In some embodiments, the memory 1030 is a non-volatile memory, such as a hard disk drive (hard disk drive, HDD) or a solid-state drive (solid-state drive, SSD), or is a volatile memory (volatile memory), such as a random access memory (random access memory, RAM). The memory is any other medium that carries or stores expected program code in a form of instructions or a data structure and that is accessed by a computer, but is not limited thereto. The memory in some embodiments alternatively is a circuit or any other apparatus that implements a storage function, and is configured to store the program instructions and/or the data.

In some embodiments, the communication apparatus in the foregoing embodiment is a terminal device, a circuit, or a chip used in the terminal device, or is another combined component or component that has functions of the terminal device. When the communication apparatus is the terminal device, the transceiver unit is the transceiver, and includes an antenna, a radio frequency circuit, and the like. The processing module is the processor, for example, a central processing unit (central processing unit, CPU). When the communication apparatus is the component that has functions of the terminal device, the transceiver unit is a radio frequency unit, and the processing module is the processor. When the communication apparatus is the chip system, the transceiver unit is an input/output interface of the chip system, and the processing module is a processor of the chip system.

FIG. 11 is a simplified schematic diagram of a structure of a communication apparatus. For ease of understanding and illustration, in FIG. 11, the communication apparatus uses an example in which a first access network device and a network device are base stations. The base station is used in the system shown in FIG. 2, is the network device in FIG. 2, and performs functions of the first access network device and the network device in the foregoing method embodiments. The communication apparatus 1100 includes one or more radio frequency units, such as a remote radio unit (remote radio unit, RRU) 1110 and one or more active antenna units (active antenna units, AAUs) (which further is referred to as digital units, digital units, DUs) 1120. The AAU is considered as a combination of a baseband unit (baseband unit, BBU) and an antenna, that is, a structure in which a radio frequency function and the antenna are integrated. An antenna port on the AAU is connected to an external RRU or a built-in radio frequency unit. The RRU 1110 is referred to as a communication module, and corresponds to the sending unit 910 and the receiving unit 920 in FIG. 9. Optionally, the communication module further is referred to as a transceiver machine, a transceiver circuit, a transceiver, or the like, and the communication module includes at least one antenna 1111 and a radio frequency unit 1112. The RRU 1110 is mainly configured to: receive and send a radio frequency signal, and perform conversion between a radio frequency signal and a baseband signal, for example, send indication information to a terminal device. The AAU 1120 is mainly configured to: perform baseband processing, control a base station, and the like. The RRU 1110 and the AAU 1120 is physically disposed together, or is physically separated, that is, in a distributed base station.

The AAU 1120 is a control center of the base station, and further is referred to as a processing module. The AAU 1120 corresponds to the processing unit 930 in FIG. 9, and is mainly configured to implement baseband processing functions such as channel coding, multiplexing, modulation, and spreading. For example, the AAU (the processing module) is configured to control the base station to perform an operation procedure related to the network device in the foregoing method embodiments, for example, generate the foregoing indication information.

In an example, the AAU 1120 includes one or more boards. A plurality of boards jointly supports a radio access network (for example, an LTE network) having a single access standard, or separately supports radio access networks (for example, the LTE network, a 5G network, or another network) having different access standards. The AAU 1120 further includes a memory 1121 and a processor 1122. The memory 1121 is configured to store instructions and data. The processor 1122 is configured to control the base station to perform an action. For example, the processor 1122 is configured to control the base station to perform the operation procedure related to the network device in the foregoing method embodiments. For example, the processor 1122 is configured to perform operations, other than sending and receiving operations, performed by the first access network device in embodiments shown in FIG. 3 to FIG. 8, and/or configured to support another process of the technology described in some embodiments. Alternatively, the processor 1122 is configured to perform operations, other than sending and receiving operations, performed by the network device in embodiments shown in FIG. 5 to FIG. 8, and/or configured to support another process of the technology described in some embodiments.

The memory 1121 and the processor 1122 may serve one or more boards. That is, a memory and a processor is independently disposed on each board. Alternatively, a plurality of boards share a same memory and a same processor. In addition, a circuit further are disposed on each board.

Some embodiments further provides a communication apparatus. The communication apparatus is a terminal or a circuit. The communication apparatus is configured to perform actions performed by the terminal in the foregoing method embodiments.

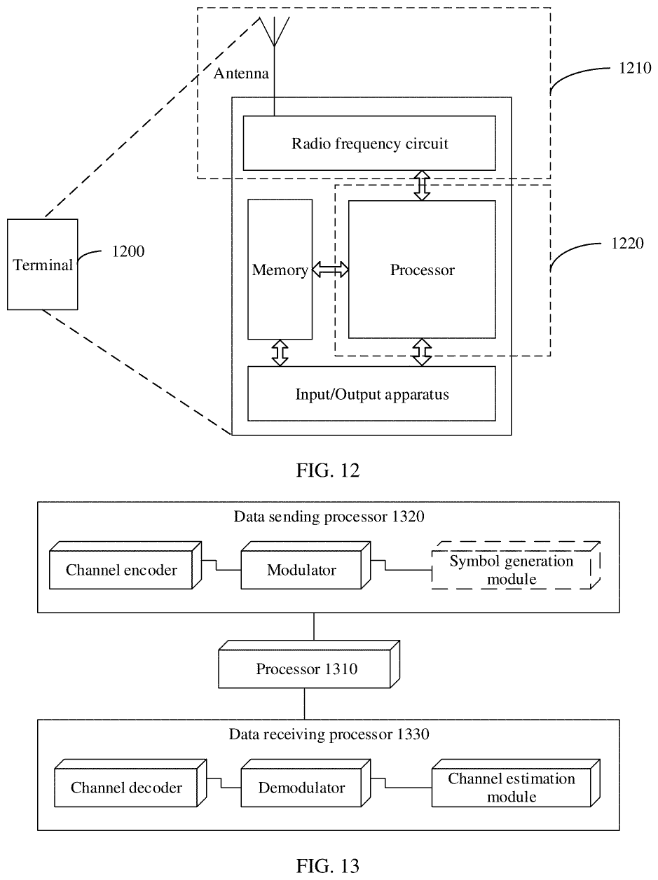

FIG. 12 is a simplified schematic diagram of a structure of a terminal. For ease of understanding and illustration, in FIG. 12, an example in which the terminal is a mobile phone is used. As shown in FIG. 12, the terminal includes a processor, a memory, a radio frequency circuit, an antenna, and an input/output apparatus. The processor is mainly configured to: process a communication protocol and communication data, control an on-board unit, execute a software program, and process data of the software program. The memory is mainly configured to store the software program and data. A radio frequency circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, such as a touchscreen, a display, or a keyboard, is mainly configured to: receive data input by a user and output data to the user. In some embodiments, some types of devices are configured to have no input/output apparatus.

When needing to send data, after performing baseband processing on the to-be-sent data, the processor outputs a baseband signal to the radio frequency circuit; and the radio frequency circuit performs radio frequency processing on the baseband signal and then sends the radio frequency signal to the outside in a form of an electromagnetic wave through the antenna. When data is sent to the device, the radio frequency circuit receives a radio frequency signal through the antenna, converts the radio frequency signal into a baseband signal, and outputs the baseband signal to the processor; and the processor converts the baseband signal into data, and processes the data. For ease of description, FIG. 12 shows one memory and one processor. In a device product, there is one or more processors and one or more memories. The memory further is referred to as a storage medium, a storage device, or the like. The memory is disposed independent of the processor, or is integrated with the processor. This is not limited in some embodiments.

In some embodiments, the antenna and the radio frequency circuit that have receiving and sending functions are considered as a transceiver unit of the apparatus, and the processor having a processing function is considered as a processing unit of the apparatus. As shown in FIG. 12, the apparatus includes a transceiver unit 1210 and a processing unit 1220. The transceiver unit 1210 further is referred to as a transceiver, a transceiver machine, a transceiver apparatus, or the like. The processing unit 1220 further is referred to as a processor, a processing board, a processing module, a processing apparatus, or the like. Optionally, a component that is in the transceiver unit 1210 and that is configured to implement a receiving function is considered as a receiving unit, and a component that is in the transceiver unit 1210 and that is configured to implement a sending function is considered as a sending unit. In other words, the transceiver unit 1210 includes the receiving unit and the sending unit. The transceiver unit 1210 sometimes further is referred to as a transceiver machine, a transceiver, a transceiver circuit, or the like. The receiving unit sometimes further is referred to as a receiver machine, a receiver, a receive circuit, or the like. The sending unit sometimes further is referred to as a transmitter machine, a transmitter, a transmit circuit, or the like.

In some embodiments, the transceiver unit 1210 is configured to perform a sending operation and a receiving operation on a terminal side in the foregoing method embodiments, and the processing unit 1220 is configured to perform an operation other than the receiving and sending operations of the terminal in the foregoing method embodiments.

For example, in an implementation, the transceiver unit 1210 is configured to perform S301 and S302 in the embodiment shown in FIG. 3, and/or configured to support another process of the technology described in some embodiments.

For another example, in an implementation, the transceiver unit 1210 is configured to perform S401a, S401b, S401, and S402 in the embodiment shown in FIG. 4, and/or configured to support another process of the technology described in some embodiments.

For another example, in an implementation, the transceiver unit 1210 is configured to perform S501a, S501b, S501, S502, and S503 in the embodiment shown in FIG. 5, and/or configured to support another process of the technology described in some embodiments.

For another example, in an implementation, the transceiver unit 1210 is configured to perform S601a, S601b, S601, S602, S603, and S604 in the embodiment shown in FIG. 6, and/or configured to support another process of the technology described in some embodiments.

For another example, in an implementation, the transceiver unit 1210 is configured to perform S701, S702, and S703 in the embodiment shown in FIG. 7, and/or configured to support another process of the technology described in some embodiments.

For another example, in an implementation, the transceiver unit 1210 is configured to perform S801, S802, and S803 in the embodiment shown in FIG. 8, and/or configured to support another process of the technology described in some embodiments.

When the communication apparatus is a chip apparatus or circuit, the apparatus includes the transceiver unit and the processing unit. The transceiver unit is an input/output circuit and/or a communication interface. The processing unit is an integrated processor, a microprocessor, or an integrated circuit.

In this embodiment, refer to an apparatus shown in FIG. 13. In an example, the apparatus implements functions similar to functions of the processing unit 930 in FIG. 9. In FIG. 13, the apparatus includes a processor 1310, a data sending processor 1320, and a data receiving processor 1330. The processing unit 930 in the foregoing embodiments is the processor 1310 in FIG. 13, and completes corresponding functions. The processing unit 930 in the foregoing embodiments is the data sending processor 1320 and/or the data receiving processor 1330 in FIG. 13. Although FIG. 13 shows a channel encoder and a channel decoder, in some embodiments, these modules are examples, and do not constitute a limitation.

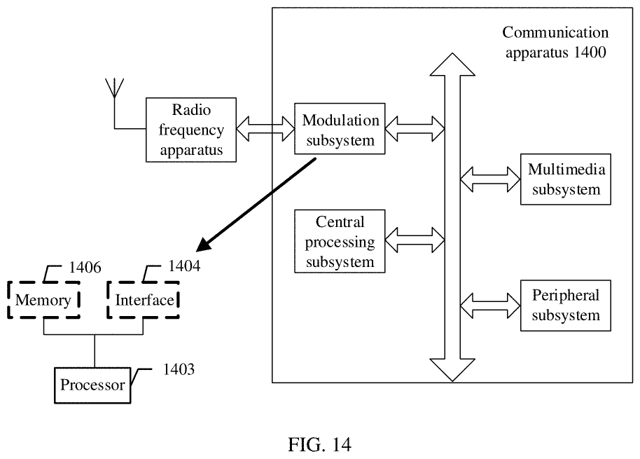

FIG. 14 shows another form of this embodiment. The communication apparatus 1400 includes modules such as a modulation subsystem, a central processing subsystem, and a peripheral subsystem. The communication apparatus in this embodiment is used as the modulation subsystem. The modulation subsystem includes a processor 1403 and an interface 1404. The processor 1403 completes the functions of the processing unit 930, and the interface 1404 completes functions of the sending unit 910 and the receiving unit 920. In another variation, the modulation subsystem includes a memory 1406, the processor 1403, and a program that is stored in the memory 1406 and that runs on the processor. When executing the program, the processor 1403 implements the method of the terminal device in the foregoing method embodiments. In some embodiments, the memory 1406 is non-volatile or volatile. The memory 1406 is located inside the modulation subsystem, or is located in the communication apparatus 1400, provided that the memory 1406 is connected to the processor 1403.

Some embodiments further provides a communication system. The communication system includes a first access network device and a terminal, includes the first access network device, the network device, and a terminal, or further includes more terminals and access network devices. For example, the communication system includes the first access network device and the terminal that are configured to implement the related functions in FIG. 3, FIG. 4, or FIG. 7. Alternatively, the communication system includes the first access network device, the network device, and the terminal that are configured to implement the related functions in FIG. 5, FIG. 6, or FIG. 8.

The first access network device is separately configured to implement functions of network parts related to FIG. 3 to FIG. 8. The terminal is configured to implement the functions of the terminals related to FIG. 3 to FIG. 8. The network device is separately configured to implement functions of network parts related to FIG. 5 to FIG. 8. For example, the first access network device performs S301 and S302 in the embodiment shown in FIG. 3, and the terminal performs S301 and S302 in the embodiment shown in FIG. 3. For another example, the first access network device performs S401a, S401b, S401, and S402 in the embodiment shown in FIG. 4, and the terminal performs S401a, S401b, S401, and S402 in the embodiment shown in FIG. 4. For another example, the first access network device performs S501a, S501b, S501, S502, and S503 in the embodiment shown in FIG. 5, the terminal performs S501a, S501b, S501, and S502 in the embodiment shown in FIG. 5, and the network device performs S503 in the embodiment shown in FIG. 5. For another example, the first access network device performs, for example, S601a, S601b, S601, S602, S603, S604, and S605 in the embodiment shown in FIG. 6, the terminal performs S601a, S601b, S601, and S602 in the embodiment shown in FIG. 6, and the network device performs S603, S604, and S605 in the embodiment shown in FIG. 6. For still another example, the first access network device performs S701 and S702 in the embodiment shown in FIG. 7, and the terminal performs S701 and S702 in the embodiment shown in FIG. 7. For still another example, the first access network device performs S801, S802, and S803 in the embodiment shown in FIG. 8, the terminal performs S801 and S802 in the embodiment shown in FIG. 8, and the network device performs S803 in the embodiment shown in FIG. 8.

Some embodiments further provides a computer-readable storage medium, including instructions. When the instructions run on a computer, the computer is enabled to perform the methods performed by the terminal, the first access network device, or the network device in FIG. 3 to FIG. 5.

Some embodiments further provide a computer program product, including computer program code. When the computer program code is run on a computer, the computer is enabled to perform the methods performed by the terminal, the first access network device, or the network device in FIG. 3 to FIG. 8.

In some embodiments, a chip system is discussed. The chip system includes a processor, further includes a memory, and is configured to implement functions of the terminal, the first access network device, or the network device in the foregoing methods. The chip system includes a chip, or includes a chip and another discrete component.

Some embodiments further provide a communication apparatus, including a processor and an interface. The processor is configured to perform the information processing method in any one of the foregoing method embodiments.

In some embodiments, the communication apparatus is a chip. The processor is implemented by hardware, or is implemented by software. When the processor is implemented by the hardware, the processor is a logic circuit, an integrated circuit, or the like. When the processor is implemented by the software, the processor is a general-purpose processor. The general-purpose processor is implemented by reading software code stored in a memory. The memory is integrated into the processor, or is located outside the processor and exist independently.

In some embodiments, the terms “system” and “network” is used interchangeably in some embodiments. “At least one” means one or more, and “a plurality of” means two or more. “And/or” describes an association relationship between associated objects, and indicates that three relationships exists. For example, A and/or B indicates the following three cases: A exists alone, both A and B exist, and B exists alone, where A and B is singular or plural. The character “/” generally indicates an “or” relationship between the associated objects. At least one of the following items (pieces) or a similar expression thereof refers to any combination of these items, including any combination of singular items (pieces) or plural items (pieces). For example, at least one item (piece) of a, b, or c indicates: a, b, c, a and b, a and c, b and c, or a, b, and c, where a, b, and c is singular or plural.

In addition, unless otherwise stated, ordinal numbers such as “first” and “second” in some embodiments are for distinguishing between a plurality of objects, but are not intended to limit an order, a time sequence, priorities, or importance of the plurality of objects. For example, a first message and a second message are intended to distinguish between different messages, but do not indicate that the two messages are different in a priority, a sending sequence, or importance.

In addition, the terms “system” and “network” is used interchangeably in some embodiments. The term “and/or” in some embodiments describes an association relationship for describing associated objects and represents that three relationships exists. For example, A and/or B represents the following three cases: A exists, both A and B exist, and B exists. In addition, the character “/” in some embodiments generally indicates an “or” relationship between the associated objects.

In some embodiments, “B corresponding to A” indicates that B is associated with A, and B is determined according to A. However, in some embodiments, determining B based on A does not mean that B is determined based on A. B alternatively is determined based on A and/or other information.

All or some of the methods in some embodiments is implemented by using software, hardware, firmware, or any combination thereof. When software is used to implement embodiments, all or a part of embodiments is implemented in a form of a computer program product. The computer program product includes one or more computer instructions. When the computer program instructions are loaded and executed on the computer, the procedure or functions according to embodiments are all or partially generated. The computer is a general-purpose computer, a dedicated computer, a computer network, a network device, user equipment, or another programmable apparatus. The computer instructions is stored in a computer-readable storage medium or is transmitted from a computer-readable storage medium to another computer-readable storage medium. For example, the computer instructions is transmitted from a website, computer, server, or data center to another website, computer, server, or data center in a wired (for example, a coaxial cable, an optical fiber, or a digital subscriber line (digital subscriber line, DSL for short)) or wireless (for example, infrared, radio, or microwave) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a digital video disc (digital video disc, DVD for short)), a semiconductor medium (for example, an SSD), or the like.

A person skilled in the art makes various modifications and variations to embodiments without departing from the scope of the embodiments. Embodiments are intended to cover these modifications and variations of the embodiments provided that these modifications and variations fall within the scope of protection defined by the following claims and equivalent technologies.

1. An information processing method, comprising:
sending, by a first access network device, application layer measurement configuration information to a terminal, wherein the application layer measurement configuration information includes identification information, and the identification information indicates a network slice; and
receiving, by the first access network device, an application layer measurement report from the terminal, wherein the application layer measurement report includes an application layer measurement result of the network slice.

2. The method according to claim 1, wherein:
the identification information includes single network slice selection assistance information (S-NSSAI).

3. The method according to claim 1, wherein:
the application layer measurement configuration information further includes a service type; and
the application layer measurement configuration information indicates to perform quality of experience measurement collection on the service type in the network slice.

4. The method according to claim 1, further comprising:
receiving, by the first access network device, a first message from a network device, wherein the first message includes the application layer measurement configuration information.

5. The method according to claim 1, further comprising:
receiving, by the first access network device, capability information from the terminal, wherein the capability information indicates that the terminal supports application layer measurement collection on the network slice.

6. The method according to claim 5, further comprising:
before the receiving the capability information from the terminal, sending, by the first access network device, a second message to the terminal, wherein the second message is used to request to obtain the capability information of the terminal.

7. The method according to claim 4, further comprising:
sending, by the first access network device, capability information of the terminal to the network device, wherein the capability information indicates that the terminal supports application layer measurement collection on the network slice.

8. The method according to claim 7, further comprising:
before the sending the capability information of the terminal to the network device, receiving, by the first access network device, a third message from the network device, wherein the third message is used to request to obtain the capability information of the terminal.

9. The method according to claim 1, further comprising:
sending, by a central unit (CU) the CU in the first access network device that includes the CU and a distributed unit (DU), the application layer measurement configuration information to the terminal; and
receiving, by the CU in the first access network device, the application layer measurement report from the terminal, and sending the application layer measurement report of the terminal to the DU in the first access network device.

10. A communication apparatus, comprising:
a sending unit, configured to send application layer measurement configuration information to a terminal, wherein the application layer measurement configuration information includes identification information, and the identification information indicates a network slice; and
a receiving unit, configured to receive an application layer measurement report from the terminal, wherein the application layer measurement report includes an application layer measurement result of the network slice.

11. The communication apparatus according to claim 10, wherein:
the identification information includes single network slice selection assistance information (S-NSSAI).

12. The communication apparatus according to claim 10, wherein:
the application layer measurement configuration information further includes a service type; and
the application layer measurement configuration information indicates to perform quality of experience measurement collection on the service type in the network slice.

13. The communication apparatus according to claim 10, wherein:
the receiving unit is further configured to:
receive a first message from a network device, wherein the first message includes the application layer measurement configuration information.

14. The communication apparatus according to claim 10, wherein the receiving unit is further configured to:
receive capability information from the terminal, wherein the capability information indicates that the terminal supports quality of experience measurement collection on the network slice.

15. The communication apparatus according to claim 14, wherein the sending unit is further configured to:
before the receiving of the capability information from the terminal, send a second message to the terminal, wherein the second message is used to request to obtain the capability information of the terminal.

16. The communication apparatus according to claim 13, wherein the sending unit is further configured to:
send capability information of the terminal to the network device, wherein the capability information indicates that the terminal supports quality of experience measurement collection on the network slice.

17. The communication apparatus according to claim 16, wherein the receiving unit is further configured to:
before the sending of the capability information of the terminal to the network device, receive a third message from the network device, wherein the third message is used to request to obtain the capability information of the terminal.

18. The communication apparatus according to claim 10, further comprises:
a first access network device that includes a central unit (CU) and a distributed unit (DU), wherein:
a CU sending unit is configured to send the application layer measurement configuration information to the terminal;
a CU receiving unit is configured to receive the application layer measurement report from the terminal; and
the CU sending unit is further configured to send the application layer measurement report of the terminal to the DU.

19. A communication apparatus, comprising:
a receiving unit, configured to receive first application layer measurement configuration information from a network device, wherein the first application layer measurement configuration information includes identification information and a service type, and the identification information indicates a network slice; and
a sending unit, configured to send second application layer measurement configuration information to a terminal, wherein the second application layer measurement configuration information indicates the terminal to perform quality of experience measurement collection on the service type, wherein:
the receiving unit is further configured to receive an application layer measurement report from the terminal, wherein the application layer measurement report comprises a result of performing application layer measurement by the terminal on the service type.

20. The communication apparatus according to claim 19, wherein:
the receiving unit is further configured to:
receive a first message from the network device, wherein the first message includes the application layer measurement configuration information.
